(19) United States
(12) Patent Application Publication
(10) Pub. No.: US 2025/0180898 A1
(43) Pub. Date: Jun. 5, 2025

(54) METALENS USED FOR BEAM SHAPING, BEAM-SHAPING SYSTEM AND GENERATING METHOD THEREOF

(71) Applicant: SHENZHEN METALENX TECHNOLOGY CO.,LTD, Shenzhen (CN)

(72) Inventors: Kelei XI, Shenzhen (CN); Yuxi Han, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/967,521

(22) Filed: Dec. 3, 2024

(30) Foreign Application Priority Data
Dec. 5, 2023 (CN) 202311656535.X
Dec. 5, 2023 (CN) 202311656540.0
Dec. 5, 2023 (CN) 202311665263.X

(51) Int. Cl. G02B 27/00; B82Y 20/00; G02B 1/00; G02B 27/09

(52) U.S. Cl. CPC G02B 27/0012; B82Y 20/00; G02B 1/002; G02B 27/0955

(57) ABSTRACT

A metalens used for beam shaping, beam-shaping system and the generating method of the metalens are provided by the present application. The metalens is used to shape an incident beam, and a divergence angle at least in one direction of an outgoing beam obtained by shaping is greater than the divergence angle in the same direction of the incident beam.

### CROSS-REFERENCE TO RELATED APPLICATIONS

This application claims the benefit of priority from Chinese Patent Application No. 202311656535.X, No. 202311656540.0, and No. 202311665263.X, filed on Dec. 5, 2023. The content of the aforementioned application, including any intervening amendments thereto, is incorporated herein by reference in its entirety.

### TECHNICAL FIELD

The present disclosure relates to the field of lenses, in particular to a metalens used for beam shaping, a beam-shaping system and a generating method thereof.

### BACKGROUND

In applications such as 3D scanning or alignment mark, the optical module usually needs to generate an elongated beam, and the elongated beam is used to scan the target objections or work as a position line on the target plane. Due to the spot corresponding to the elongated beam is usually in shape of a line, the elongated beam is called as a line-shape beam.

The flat-top beam is a type of beam with a uniform distribution of optical intensity in the central region and a sharp drop-off at the edges. The flat-top beam is widely used in fields such as laser medicine or laser etching. The higher the uniformity of the flat-top beam, the evener the distribution of optical intensity in the central region.

### SUMMARY

In order to solve the problems in the prior art, a metalens used for beam shaping, a beam-shaping system and a generating method for the metalens are provided according to the embodiments of the present application.

In the first aspect of the present application, a metalens used for beam shaping is provided, and the metalens is used to shape an incident beam, and a divergence angle at least in one direction of an outgoing beam obtained by shaping is greater than the divergence angle in the same direction of the incident beam.

In one embodiment, the incident beam is a Gaussian beam.

In one embodiment, a diameter of the metalens is greater than or equal to 1.3 times a spot diameter of the Gaussian beam projected on the metalens, and is less than or equal to 1.7 times the spot diameter.

In one embodiment, the metalens is used to align a beam emitted by a point light source and expand the beam emitted by the point light source in the expended direction; the outgoing shaped beam is a line-shape beam.

In one embodiment, the metalens is further used to compress a line width of the beam emitted by the point light source in a direction of line width.

In one embodiment, the metalens is used to provide different focal lengths for beams with different divergence angles to adaptively compress the line widths of beams with different divergence angles.

In one embodiment, the metalens is used to shape a Gaussian beam into a second flat-top beam, and is used to copy and splice the second flat-top beam to a first flat-top beam; a first divergence angle of the first flat-top beam is greater than the second divergence angle of the second flat-top beam.

In one embodiment, a 2D coordinate system representing a beam observation surface comprises a first-direction axis and a second-direction axis, and the first-direction axis and the second-direction axis are perpendicular to each other;
the metalens is used to copy and splice the second flat-top beam both on the first-direction axis and the second-direction axis.

In one embodiment, the first divergence is an integer multiple of the second divergence angle.

In the second aspect of the application, a beam-shaping system is provided, the beam-shaping system includes a light source and the metalens;
the metalens is set on an outgoing side of the light source.

In one embodiment, the light source is a single point light source.

In one embodiment, the light source is an array comprising a plurality of point light sources.

In the third aspect of the application, a generating method of a metalens is provided, the method is used to generate the metalens claimed as claim 1, wherein the method comprises:
analyzing a shaping phase used to shape a parallel beam into a target light field by using a recombinant light intensity distribution; wherein an input of the recombinant light intensity is the light intensity distribution of the beam emitted by the point light source; an output of the recombinant light intensity is the light intensity distribution of a first light field, and an initial state of the first light field is set as the target light field;
obtaining a second light field by shaping a beam emitted by the point light source based on a superposition phase and detecting a deviation between the light intensity distribution of the second light field and the light intensity distribution of the target light field; wherein the superposition phase comprises a collimation phase and a shaping phase, and the shaping phase is used to align the beam emitted by the point light source to the parallel beams;
every time detecting the deviation and the deviation is greater than a preset threshold, optimizing the light intensity distribution of the first light field based on the deviation, and re-analyzing the shaping phase, re-obtaining the second light field, re-detecting the deviation until the detected deviation is less than or equal to the preset threshold;
generating the metalens used for shaping the beam emitted by the point light source into a line-shape beam based on the superposition phase; and the line-shape beam corresponds to the target light field.

In one embodiment, the shaping phase comprises an expended phase, and the expended phase is used to shape the parallel beam into the line-shape beam with a target divergence angle.

In one embodiment, wherein the shaping phase comprises a compressed phase for a line width, and the compressed phase for a line width is used for shaping the parallel beam into the line-shape beam that meets a target line width.

In one embodiment, “analyzing a shaping phase used to shape a parallel beam as a target light field by using a recombinant light intensity distribution” comprises:
obtaining a target focal length that the metalens provides for each light with a deflection angle, so as to make the line-shape beam satisfy the target line width;
analyzing and obtaining the compressed phase for the line phase based on the deflection angle required for each light on the metalens and the target focal length that the metalens provides for each light with a deflection angle.

In the fourth aspect, a generating method is provided, and the generating method is used to generate the metalens, the metalens to be generated is used to shape the Gaussian beam into the first flat-top beam, and the first flat-top beam satisfies the first divergence angle and a preset uniformity; and the method comprises:
obtaining a second uniform phase, and the second uniform phase is used to shape the Gaussian beam into the second flat-top beam, wherein the second flat-top beam satisfies the second divergence angle and the preset uniformity; and the second divergence angle is less than the first divergence angle;
obtaining the first flat-top beam by copying and splicing, the copied number of the second flat-top beam and a diffraction angle required by the second flat-top beam after copying based on the first divergence angle and the second divergence angle;
based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam;
recovering the target image, and obtaining a copying-splicing phase of the nanostructures with the position distribution that required the copying-splicing; generating a metalens used for shaping the Gaussian beam into the first flat-top beam based on the second uniform phase and the copying-splicing beam.

In one embodiment, “obtaining the first flat-top beam by copying and splicing, the copied number of the second flat-top beam and a diffraction angle required by the second flat-top beam after copying based on the first divergence and the second divergence” comprises:
obtaining the copied number by calculating a ratio of the first divergence angle to the second divergence angle;
obtaining the diffraction angle by calculating the copied number and the second divergence angle; wherein the diffraction angle is positively correlated with the copied number, and is positively correlated with the second divergence angle.

In one embodiment, a 2D coordinate system representing a beam observation surface includes a first-direction axis and a second-direction axis, and the first-direction axis and the second-direction axis are perpendicular to each other; the copied number comprises a first number and a second number; the first number is the copied number required on the first directional axis, and the second number is the copied number required on the second-direction axis, the diffraction angle comprises the diffraction angle required on the first-direction axis and the diffraction angle required on the second-direction axis.

In one embodiment, “based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam” comprises:
calculating the sampling number of the nanostructures to be arranged based on the diameter of the spot that the Gaussian beam projects on the metalens and the sampling period of the nanostructures to be arranged; and the sampling period and the sampling number constitute the position distribution;
calculating and obtaining a period of the pixels to be arranged in the target image based on the copied number, the diffraction angle, the wavelength of the second flat-top beam, the sampling period and the sampling number;
determining a target size of the target image based on the sampling period and the sampling number; according to the copied number and the arranged period, obtaining the target image by arranging the pixels in the target size image; wherein the target the pixel array is composed of the pixels of the copied number, and the distance between the adjacent pixels satisfies the arranged period.

The metalens used for beam shaping, the metalens has a divergence angle that can expend the beam at least in one direction, thus the metalens is used for shaping beams and obtaining the line-shape beams or the flat-top beams.

Other features and advantages of the present application will become apparent in the detailed description below or will be acquired in part by the practice of the present application.

It should be understood that the above general description and detailed details are exemplary only, and do not limit this application.

### BRIEF DESCRIPTION OF THE DRAWINGS

The present disclosure may be better understood by reference to the description given below in combination with the drawings, where the same or similar drawing markings are used in all the drawings to represent the same or similar assemblies. The drawings are included in the specification along with the following detailed description and form part of the specification, and to further illustrate the preferred embodiments of the application and explain the principles and advantages of the disclosure.

FIG. 1 shows a flow chart of a generating method for the metalens in one embodiment of the present application.

FIG. 2 shows a detailed flow chart of the metalens generating method for the metalens in one embodiment of this application.

FIG. 3 shows a schematic layout of the beam-shaping system in one embodiment of the present application.

FIG. 4 shows a schematic spot view of a line-shaped beam generated in an embodiment of the present application.

FIG. 5 shows a schematic diagram of the distribution of the normalized light intensity in the expanded direction of the line-shape beam in the embodiment of FIG. 4.

FIG. 6 shows a schematic diagram of the distribution of normalized light intensity in the line width direction of the line-shape beam in the embodiment of FIG. 4.

FIG. 7 shows a spot diagram of a line-shape beam in an embodiment of this application.

FIG. 8 shows a schematic diagram of the distribution of the normalized light intensity of the line-shape in the expanded direction in the embodiment of FIG. 7.

FIG. 9 shows a schematic diagram of the distribution of the normalized light intensity in the line width direction generated in the embodiment of FIG. 7.

FIG. 10 shows a spot diagram of a line-shaped beam in an embodiment of this application.

FIG. 11 shows a schematic diagram of the distribution of the normalized light intensity in the expanded direction in the embodiment of FIG. 10.

FIG. 12 shows a schematic distribution of the normalized light intensity in the line width direction of the generated line-shape beam in the embodiment of FIG. 10.

FIG. 13 shows a spot diagram of a line-shape beam generated in an embodiment of this application.

FIG. 14 shows a schematic diagram of the distribution of the normalized light intensity in the expanded direction in the embodiment of FIG. 13.

FIG. 15 shows a schematic distribution of the normalized light intensity in the line width direction of the line-shape beam in the embodiment of FIG. 13.

FIG. 16 shows a schematic diagram of a spot obtained by the line-shape beam generated in an embodiment of this application.

FIG. 17 shows a schematic diagram of a spot obtained by the line-shape beam generated in an embodiment of this application.

FIG. 18 shows a flowchart of a generating method of the metalens in one embodiment of this application.

FIG. 19 shows a schematic view of shaping a Gaussian beam into a second flat-top beam in the embodiment of this application.

FIG. 20 shows a schematic diagram of copying and splicing the second flat-top beam shown in FIG. 19 into the first flat-top beam in the embodiment of the present application.

FIG. 21 shows a schematic diagram of shaping the second flat-top beam into the first flat-top beam on the beam observation surface in the embodiment of this application.

FIG. 22 shows a schematic diagram of the distribution of the two-dimensional normalized light intensity of the flat-top beam formed in the embodiment of FIG. 21.

FIG. 23 shows a schematic diagram of the distribution of the one-dimensional normalized light intensity in the horizontal direction of the first flat-top beam formed in the embodiment of FIG. 21.

FIG. 24 shows a layout diagram of the beam-shaping system in one embodiment of the present application.

FIG. 25 shows a block diagram of a generating device of the metalens in one embodiment of the present application.

FIG. 26 shows a block diagram of a generating device of the metalens in one embodiment of the present application.

### DETAILED DESCRIPTION OF THE EMBODIMENTS

The embodiment will now be described more comprehensively with reference to the accompanying drawings. However, the embodiments can be implemented in various forms and should not be understood to be limited to the examples elaborated herein; instead, providing these embodiments makes the description of this application more comprehensive and complete and fully communicates the idea of the exemplary embodiment to those skilled in the art. The attached drawings are only schematic illustrations of this application and are not necessarily proportional drawings. The same reference marks in the figure indicate the same or similar parts, and their repeated descriptions will be omitted.

Furthermore, the described features, structures or features may be combined in one or more embodiments in any suitable manner. In the following description, many specific details are provided to give a full understanding of the embodiments of this application. However, those skilled in the art will be aware that one or more of the specific details may be omitted from the present technical solution (or other modules, components etc.) may be adopted. In other cases, aspects of the present application are blurred without detailed showing or describing the public structure, method, implementation or operation to avoid over-dominance.

Some of the box plots shown in the accompanying drawings are functional entities and do not necessarily have to correspond to physically or logically separate entities. These functional entities can be implemented in the form of software, either in one or more hardware modules or integrated circuits, or in different networks and/or processing unit devices and/or micro-controlled devices.

The present application provides a metalens used for beam shaping. The metalens is used to shape the incident beam, and a divergence angle at least in one direction of the outgoing beam obtained by shaping is greater than the divergence angle in the same direction of the incident beam.

In one embodiment, the incident beam is a Gaussian beam.

In one embodiment, in order to enable the metalens to receive most of the energy of the Gaussian beam to achieve higher optical efficiency and the size and the cost of the metalens will not be too large, considering the light intensity of the Gaussian beam, a diameter of the metalens is greater than or equal to 1.3 times of a spot diameter of the Gaussian beam projected on the metalens, and is less than or equal to 1.7 times of the diameter of the spot diameter.

For the spot that the Gaussian beam projecting on the metalens, the biggest light intensity of the spot may be measured firstly, then the position of the 1/e² times of biggest light intensity of the spot is measured; the position of 1/e² times of biggest light intensity is an edge position of the spot; the diameter of the spot of the central position may be determined by the edge position of the spot and the central position of the spot.

When the diameter of the metalens is less than 1.3 times the diameter of the spot, the optical efficiency of the metalens will be too low; when the diameter of the metalens is greater than 1.7 times the diameter of the spot, the optical efficiency of the metalens will be higher, but the size and the cost of the metalens will be too high.

Preferably, in one embodiment, the diameter of the metalens is greater than or equal to 1.4 times the spot diameter that the Gaussian beam projecting on the metalens, and the diameter of the metalens is less than or equal to 1.6 times the spot diameter that the Gaussian beam projecting on the metalens.

In one embodiment, the incident beam is emitted by the point light source. The metalens is used to align the beam emitted by the point light source and expend the beam in the expended direction. And the incident beam is shaped into a line-shape beam by the metalens.

The spot of the line-shape beam is usually in the shape of a line. And the divergence angle of the line-shape beam refers to an angle between the outer light of the line-shape beam and the vertical-central line of the metalens; and the vertical-central line of the metalens passes through the center of the metalens and is perpendicular to the metalens.

Only one piece of the metalens provided by the present application can shape the beam emitted by the point light source into the line-shape beam without setting additional lenses. In this way, the design complexity, the cost and the volume of the system will be reduced at the same time. During the interaction with users, if the metalens is damaged due to the accident, the modulation effect for lights of the whole system will fail, and then the incident beam emitted by the point light source with high power will constantly spread out and the power density will decrease, which greatly reduces the possibility of damage to the safety of the human eyes, and reduces the security risk for human eyes of users in the process of interaction.

In one embodiment, the metalens is used to align the incident beam emitted by the point light source, and the metalens is used to expend the incident beam in the expended direction and compress the line width in the line-width direction. In this way, the incident beam is shaped into a line-shape beam satisfying the target line width.

Further, the metalens provides different target focal lengths for different lights with different divergence angles, and different line widths of lights with different divergence angles are compressed adaptively.

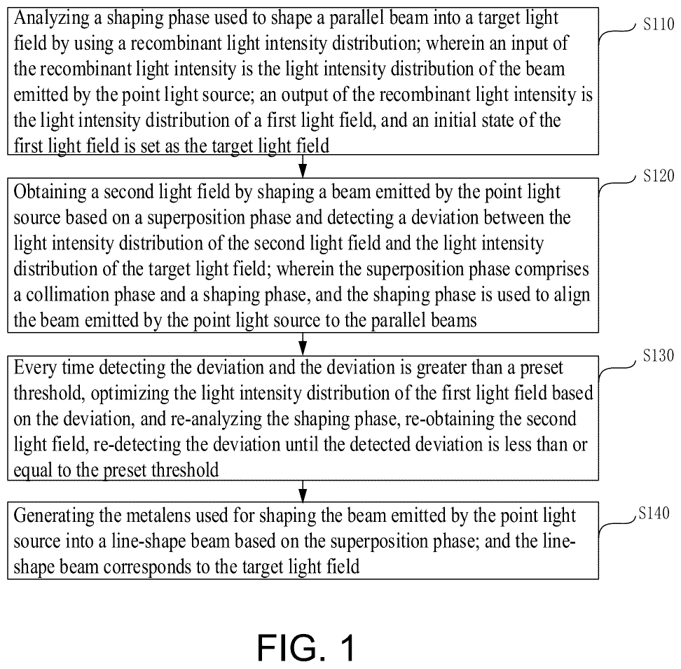

FIG. 1 shows a flow chart of a generating method for a metalens in one embodiment. As shown in FIG. 1, the generating method includes:
analyzing a shaping phase used to shape a parallel beam into a target light field by using a recombinant light intensity distribution; wherein an input of the recombinant light intensity is the light intensity distribution of the beam emitted by the point light source; an output of the recombinant light intensity is the light intensity distribution of a first light field, and an initial state of the first light field is set as the target light field;
obtaining a second light field through shaping a beam emitted by the point light source based on a superposition phase and detecting a deviation between the light intensity distribution of the second light field and the light intensity distribution of the target light field; wherein the superposition phase comprises a collimation phase and a shaping phase, and the shaping phase is used to align the beam emitted by the point light source to the parallel beams;
every time detecting the deviation and the deviation is greater than a preset threshold, optimizing the light intensity distribution of the first light field based on the deviation, and re-analyzing the shaping phase, re-obtaining the second light field, re-detecting the deviation until the detected deviation is less than or equal to the preset threshold;
generating the metalens used for shaping the beam emitted by the point light source into a line-shape beam based on the superposition phase; and the line-shape beam corresponds to the target light field.

In one embodiment, a metalens to be generated is used to shape the incident beam emitted by the point light source (may be a single point light source, or may be an array including many point light sources) into a line-shape beam. After a target requirement for line-shape beams is determined, the light field for the line-shape beam is determined. And after the distance between the point light source and the metalens is determined, the light intensity distribution of the incident beam emitted by the point light source on the metalens can be determined. Therefore, based on the generalized Snell's law and the law of conservation of energy, and analyze the shaping phase that is used to shape the parallel beams emitted by the point light source into the line-shape beams with the target light field by the recombinant light intensity distribution.

Specifically, according to the generalized Snell's law, when the beam is perpendicularly incident to the medium, the phase of the light may be calculated by the deflection angle of the light and the refractive index of the medium. The sum of energy of the light intensity distribution of the incident beam emitted by the point light source on the metalens is equal to the sum of the light intensity distribution of the target light field. Therefore, the beams emitted by the point light source are regarded as vertical incident beams to the metalens (that is, the incident beams on the metalens are regarded as the parallel beam emitted by the point light source), and the light intensity distribution of the target light field may be obtained by providing all the lights on the metalens with specific deflection angles and recombining the light intensity distribution of the incident beams emitted by the point light source on the metalens. Further, the required phases of all the lights on the metalens are determined by the deflection angles of all the lights on the metalens. The set of the required phases of lights on the metalens is the shaping phase of the line-shape beam with the target light field, and the shaping phase is used to shape the parallel beams into the line-shape beam with the target light field.

It should be noted that after analyzing the shaping phase by using the recombinant light intensity distribution, the first analysis of the shaping phase may be regarded as the phase distribution required by the metalens. However, the applicants realized that “the first analysis of the shaping phase may be regarded as the phase distribution required by the metalens” is based on the premise that the coherence of the beams emitted by the point light source is quite low.

Specifically, when the coherence of the beams emitted by the point light source is quite low, which may be simply regarded as lights without interference diffraction. In this case, the light field can be directly considered as the superposition of intensities. However, when the coherence of the beams emitted by the point light source is quite high, which may not be treated as beams without interference diffraction. In this case, the light field should be considered as the superposition of multiple amplitudes. Therefore, when the coherence of the beams emitted by the point light source is quite low, the metalens can use the first analysis of the shaping phase to shape the parallel beams emitted by the point light source, and the target light field is obtained. However, when the coherence of the light beam emitted by a point light source is quite high, if the metalens uses the first analysis of the shaping phase to shape the parallel beams emitted by the point light source, there may be a greater deviation between the shaped light field and the target light field.

Therefore, in order to obtain a suitable shaping phase when the coherence of the beams emitted by the point light source is quite high. In the present application, the shaping phase may be analyzed by multiple iterations. During the iteration process, the initial state is inputted as the first light field of the target light field (that is, in the first iteration, the first light field is the target light field), and the first light field is taken as the direct output of recombinant light intensity and the direct optimal object.

Specifically, every time optimized iteration including: recombining the light intensity distribution of the beams emitted by the point light source on the metalens, so as to output the light intensity distribution; according to the diffraction angle of each light on the metalens, analyzing and obtaining the corresponding shaping phase; after obtaining the shaping phase, the second light field is obtained. And the collimation phase may be aligned with the beams emitted by the point light source into parallel beams, and the shaping phase is used to shape the parallel beams into the second light field. The second light field reflects the actual shaping effect of the shaping phase for the corresponding parallel beams. Therefore, after obtaining the second light field, the deviation between the light intensity distribution of the second light field and the light intensity distribution of the target light intensity.

If the deviation is greater than the preset threshold, the shaping phase obtained by the iteration doesn't satisfy the expected shaping effect. Therefore, based on the deviation, the light intensity of the first light field is optimized by correcting the light intensity distribution of the first light field. And the next iteration is started based on the optimized first light field, that is, re-analyzing the shaping phase, re-obtaining the second light field, and re-detecting the deviation between the light intensity distribution of the second light field and the light intensity distribution of the target light field.

The iterations keep going on and on, until the deviation is less than or equal to the preset threshold, which indicates the shaping phase can satisfy the preset shaping effect. Therefore, the superposition phase of the shaping phase and the collimation phase can be determined as the required phase distribution of the metalens. After determining the required phase distribution of the metalens, the nanostructure that can provide the corresponding phase may be searched and selected from the pre-constructed nanostructure database, and then the layout of the metalens can be obtained. Then, according to the obtained layout, the metalens satisfying the target requirements may be obtained by processing, that is, the obtained metalens is able to shape the beams emitted by the point light source into line-shape beams.

It should be noted that in the present embodiment, the optimized object of each iteration is the light intensity distribution of the first light field. It is obvious that the light intensity distribution of the first light field can reflect the specific light intensity of each light directly, and the initial state of the first light field is set to be the target light field, so the step of “optimizing the light intensity distribution of the first light field to make the difference between the light intensity distribution of the second light field and the target light intensity distribution of the light field less than or equal to the preset threshold” has enough interpret-ability. Thus, the upper limitation of the optimization iteration efficiency increases, and the convergence rate of the optimization iteration increases. In this way, when generating the metalens, the required phase distribution of the metalens can be determined efficiently.

In one embodiment, the shaping phase includes an expended phase, and the expended phase is used to shape the parallel beam into a line-shape beam with a target divergence angle to realize the expending effect for lights.

In one embodiment, “analyzing a shaping phase used to shape a parallel beam as a target light field by using a recombinant light intensity distribution” includes:
obtaining a target focal length that the metalens provides for each light with a deflection angle, so as to make the line-shape beam satisfy the target line width;
analyzing and obtaining the compressed phase for the line width based on the deflection angle required for each light on the metalens and the target focal length that the metalens provides for each light with a deflection angle.

In one embodiment, in the first time of the iteration, after determining the target divergence angle for the line-shape beam, according to the uniform distribution for the line-shape beam, the light intensity distribution of the target light field that meets the target divergence angle is determined, so as to obtain the light intensity distribution of the first light field that meets the target divergence angle. Then, according to the law of energy conservation, the corresponding deflection angle can be applied to each light on the metalens, so as to recombine the light intensity distribution of the beams emitted by the point light source on the metalens. And the recombinant light intensity distribution is taken as the light intensity distribution of the first light field satisfied the target divergence angle. In the recombining process, the deflection angle applied to each light on the metalens is the required deflection angle for each light on the metalens. Because the thickness of the metalens is very thin, the metalens may be equivalent to an interface between the medium with no thickness. The expended phase may be analyzed and obtained based on the generalized Snell's law, the required deflection angle for each light on the metalens and the refractive index of the medium on both sides of the metalens (in general, both the media between the metalens are air; in some situations, the media on both sides of the metalens may be other materials except for air; when both media of the metalens are air, the refractive index of both media on both sides of the metalens can be recorded as 1).

After obtaining the expanded phase, the expanded phase is superposed with the collimation phase. Then, the beams emitted by the point light source can be shaped by simulation, and the second light field of the superposition phase is obtained, and then the deviation between the light intensity distribution of the second light field and the light intensity distribution of the target light field is detected. If the detected deviation is greater than the preset threshold, the light intensity distribution of the first light field satisfying the target divergence angle is optimized based on the deviation, so that the light intensity distribution of the first light field satisfying the target divergence angle used as the recombinant output in the second iteration is obtained, and then the second iteration can be started. This iteration will not stop until a detected deviation is less than or equal to the preset threshold.

It should be noted that the target uniformity distribution can be flexibly set for the line-shape beam according to the application requirements. In detail, the target uniformity distribution can require the target light field of the line-shape beam in the expending direction to keep the light intensity distribution consistent; the target light field of the line-shape beam on the two ends of the expending direction is strong, and the light intensity F the line-shape beam in the middle of the expending direction is weak.

In one embodiment, the shaping phase doesn't only include the expanded phase, but also includes the compressed phase for line width. The compressed phase for line width is used to shape the parallel beams into the line-shape beam satisfying the target line width.

It should be noted that when designing the expended phase, even if the line width of the line-shape beam in the target light field is set as a uniform state, the line-shape beam based on the superposition phase shaping of the expended phase has different line widths. The applicants of the present application found that the propagation distance of the light with different divergence angles is different, so the line-shape beam will have different expansions in the direction of the line width. Thus, the line width near the edge of the line-shape beam is larger, and the line width of the line-shape beam is different from the target line width. And the uneven line width will cause an adverse effect on the uniformity of the light intensity distribution. Therefore, in this embodiment, the compressed phase for line width besides the expended phase is provided to shape the parallel beam into a line-shape beam satisfying the target line width.

In one embodiment, “analyzing a shaping phase used to shape a parallel beam as a target light field by using a recombinant light intensity distribution” includes:
obtaining a target focal length that the metalens provides for each light with a deflection angle, so as to make the line-shape beam satisfy the target line width;
analyzing and obtaining the compressed phase for the line width based on the deflection angle required for each light on the metalens and the target focal length that the metalens provides for each light with a deflection angle.

In this embodiment, the target focal lengths required by the metalens for different deflection angles are obtained to ensure that the line width of the line-shape beam meets the target line width. The metalens adaptively compresses the line width of the light beam corresponding to different deflection angles by providing different target focal lengths for different deflection angles.

Since during each iteration, the deflection angles required for all lights on the metalens are determined during the process of analyzing the expended phase, combining the deflection angles required for each light at different locations on the metalens with the target focal lengths required by the metalens for different deflection angles, the target focal lengths required for the lights at different locations on the metalens are determined. Based on the relationship between the collimation phase and focal length, the target focal lengths required for the lights at different locations on the metalens can be converted into the corresponding compressed phases for line width.

In one embodiment, the target focal length is required for the metalens to provide the line-shape beam satisfying the target line width, the step including:
based on the distance between the metalens and the point light source and the target line width, obtaining the target focal length provided by the metalens required for the lights with 0-degree deflection angle;
based on the target focal length provided by the metalens for the 0-degree deflection angle, adjusting the focal length provided by the metalens for the lights of each deflection angle, and calculating the actual line width of the line-shape beam obtained by the lights at the corresponding focal length;
based on the actual line width, selecting the target focal length of the metalens for the lights of the deflection angle.

It should be noted that the main factor influencing the line width is the distance between the metalens and the point light source. It is understandable that the beams emitted by the point light source spread outwards continuously. The greater the distance between the metalens and the point light source, the larger the radius of the spot region of the beams emitted by the point light source on the metalens. Therefore, if the line width of the line-shape beam is not controlled specially, the overall line width of the line-shape beam will be larger. Conversely, the smaller the distance between the metalens and the point light source, the smaller the radius of the spot region of the beams emitted by the point light source on the metalens, thus the overall line width of the line-shape beam will be smaller if not controlled especially.

Therefore, in this embodiment, the distance between the metalens and the point light source is determined first, and the outgoing lights from the metalens are all set to have a 0-degree deflection angle. Then, the target focal lengths required by the metalens for the beams with 0-degree deflection angles are determined to ensure that the line-shape beam meets the target line width. Subsequently, the target focal lengths required by the metalens for the beams with 0-degree deflection angles as a reference, and the target focal lengths required by the metalens for beams with different deflection angles are determined.

In detail, all the outgoing lights from the metalens are set to have specific deflection angles. The metalens first provides the target focal length corresponding to a 0-degree deflection angle for the specific deflection angle, thereby obtaining the actual line width of the line-shape beam under the target focal length corresponding to the 0-degree deflection angle. Then, the deviation between the actual line width and the reference line width is detected. Based on this deviation, the target focal length corresponding to the 0-degree deflection angle is adjusted to obtain the adjusted focal length (the reference line width may be the target line width, or the actual line width of the line-shape beam obtained under the target focal length corresponding to the 0-degree deflection angle). Next, the metalens provides the adjusted focal length for the specific deflection angle, thereby obtaining the actual line width of the line-shape beam under the adjusted focal length. The deviation between the actual line width and the target line width is re-detected, and based on this deviation the adjusted focal length is adjusted. This process is repeated until the deviation between the actual line width and the target line width is less than or equal to a threshold of preset line width deviation, thereby obtaining the target focal length required by the metalens for the specific deflection angle.

Alternatively, all the outgoing lights from the metalens can be set to have a specific deflection angle, and multiple groups of the focal lengths to be verified can be obtained by adjusting based on the target focal length corresponding to the 0-degree deflection angle. Then, the metalens provides each group of the focal lengths to be verified for the specific deflection angle, thereby obtaining the actual line widths of the line-shape beams corresponding to each group of the focal length. Next, the deviations between each actual line width and the reference of the line width are detected, and the focal length to be verified with the smallest deviation is determined to be the target focal length required by the metalens for the specific deflection angle.

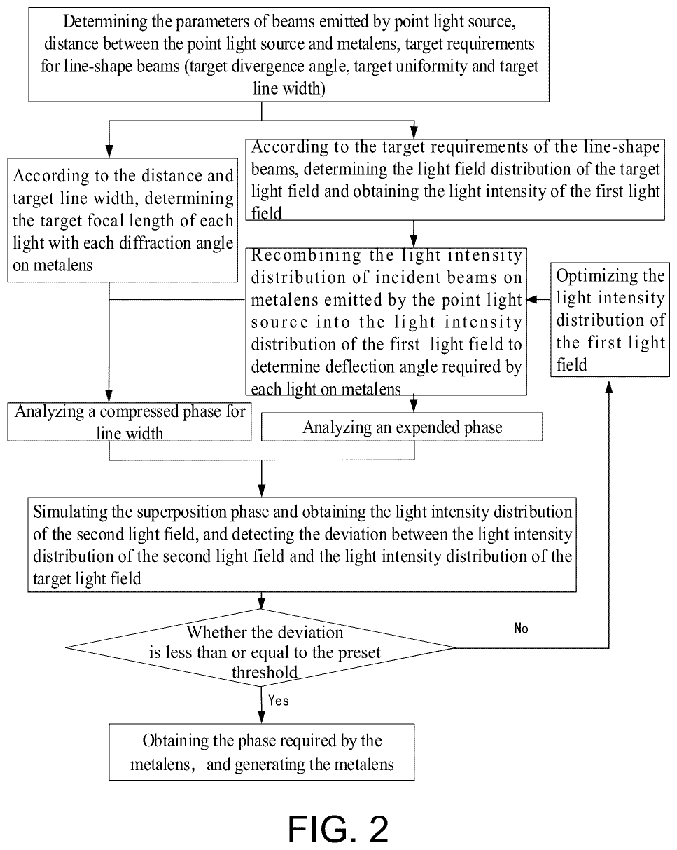

FIG. 2 shows a detailed flowchart of the generating method for a metalens according to one embodiment of the present application. Referring to FIG. 2, in one embodiment, the parameters of the beams emitted by the point light source (the wavelength, the divergence angle, etc.) are determined, and the distance between the point light source and the metalens and the target requirements for the line-shape beam (such as the target divergence angle, target uniformity distribution and target line width) are determined.

Based on the target requirements for the line-shape beam, the light intensity distribution of the target light field can be determined, and this intensity distribution can be used as the light intensity distribution of the first light field during the first iteration. Additionally, based on the distance between the point light source and the metalens, and the target line width, the target focal lengths required by the metalens for lights with different deflection angles can be determined.

The first iteration, that is, recombining the light intensity distribution of beams emitted by the point light source on the metalens to be the first light field distribution, the deflection angle required by each light on the metalens. Based on the generalized Snell's law, the expended phase φ_{2SH} (x,y) is obtained according to the deflection angle with each light on the metalens. And the target focal length and the target focal length required by all lights on the metalens, thus the target focal length required by all lights on the metalens is converted to the corresponding compressed phase for line width φ_{2LW}(x,y) according to the relationship between the collimation phase and the focal length. The expended phase φ_{2SH}(x,y) and the compressed phase for line width φ_{2LW}(x,y) form the shaping phase φ_{2SH}(x,y), and the superposition phase φ₁(x,y)+φ₂(x,y) is obtained by calculating the shaping phase φ₂ (x,y) and the collimation phase φ₁(x,y). And the superposition phase φ₁(x,y)+φ₂(x,y) is simulated, then the second light field is obtained by shaping the beams emitted by the point light source, and then the deviation between the light intensity of the second light field and the light intensity of the target light field. If the deviation is greater than the preset threshold, the light intensity distribution is optimized, and then the second iteration is started.

Similarly to the detailed process of the first iteration, the detailed process of the second iteration and each subsequent iteration will not be described here. The iterations keep going on and on until the deviation is less than or equal to the preset threshold, then the phase distribution φ₁(x,y)+φ₂(x,y) required by the metalens is obtained, a metalens can be generated to shape the beams emitted by the point light source into a line-shape beam that meets the target requirements.

In the present application, the compressed phase for line width φ_{2LW}(x,y) may be described as follows:

$${φ}_{2 LW} ( x , y ) = - k * \frac{{x}^{2}}{2 {f}_{x}}$$

Wherein, k is a wave vector, x is a position of the line-shape beam in the expending direction, fₓ is a target focal length required by a corresponding position of the metalens.

In one embodiment, according to the deviation, optimizing the first light field distribution including:
adapting a pre-constructed light intensity distribution to describe the first light field, and obtaining the light intensity distribution of the first light field;
optimizing the first light field by adjusting the coefficients in the expression of the light intensity distribution of the first light field.

In one embodiment, the mathematical expression is used to describe and optimize the light intensity distribution of the first light field.

In detail, the light intensity distribution expression (e. g., a multi-order polynomial) is pre-constructed to describe the light intensity distribution of the first light field. Therefore, the light intensity distribution of the first light field can be changed by adjusting the coefficient in the expression of the light intensity distribution of the first light field, thus realizing the optimization of the first light field.

In one embodiment, according to the deviation, optimizing the first light field distribution including:
discretizing the light intensity distribution of the first light field, so as to obtain the discretized light intensity distribution of the first light field;
optimizing the light intensity distribution of the first light field by adjusting the field.

In this embodiment, the light intensity distribution of the first light field is described and optimized by discrete values.

In detail, the light intensity of the first optical field is discretized to be multiple discretized values, thus the discretized light intensity distribution of the first light field is obtained. Therefore, the discretized light intensity at any position in the first light field may be arbitrarily changed directly to realize the optimization of the first light field.

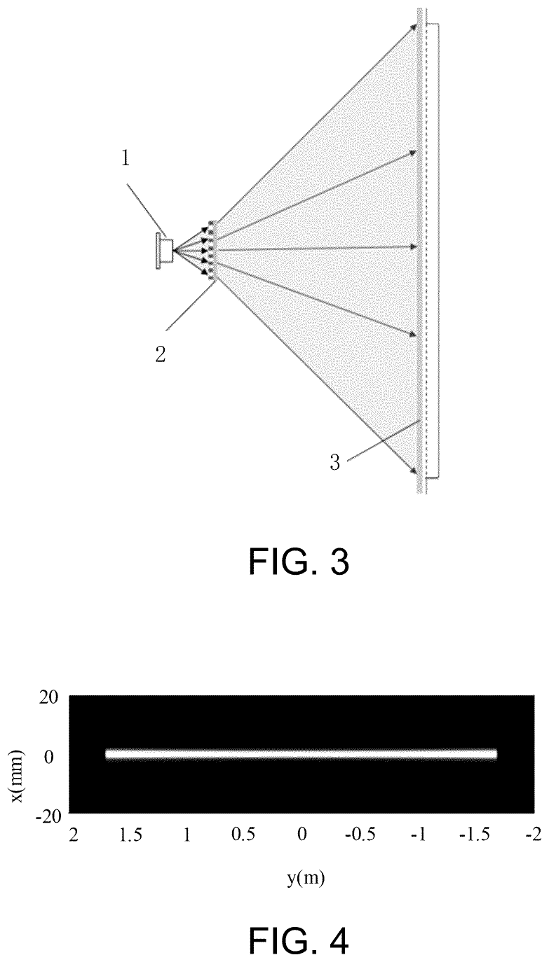

The present application provides a beam-shaping system. FIG. 3 shows a layout diagram of the beam-shaping system. As shown in FIG. 3, the beam-shaping system includes a light source 1 and the metalens 2 as mentioned above; the metalens 2 is set on the outgoing side of the light source 1. The metalens 2 is generating by using the methods provided by one of the above embodiments. In the beam-shaping system provided in the present application, the incident beams emitted by the point light source 1 pass through the metalens 2, and the incident beams are modulated into line-shape beams. On the beam observation surface 3 at a certain distance from the metalens 2, the line-shape beam will project a line-shaped spot.

In one embodiment, the uniformity performance of the line-shape beam may be calculated by following formula:

$$A = \frac{{I}_{m ax} - {I}_{m i n}}{{I}_{m ax} + {I}_{m i n}}$$

Iₘₐₓ represents the maximum light intensity of the line-shape beam at region of the target divergence angle, Iₘᵢₙ represents minimum light intensity of the line-shape beam at region of the target divergence angle, A represents the uniformity performance. The smaller A is, the uniformity of the line-shape beam is better; conversely, the larger A is, the uniformity of the line-shape beam is worse. However, if the application requirement does not require a high uniformity of line-shape beams, the uniformity performance A may be not used as a performance test item of line-shape beam.

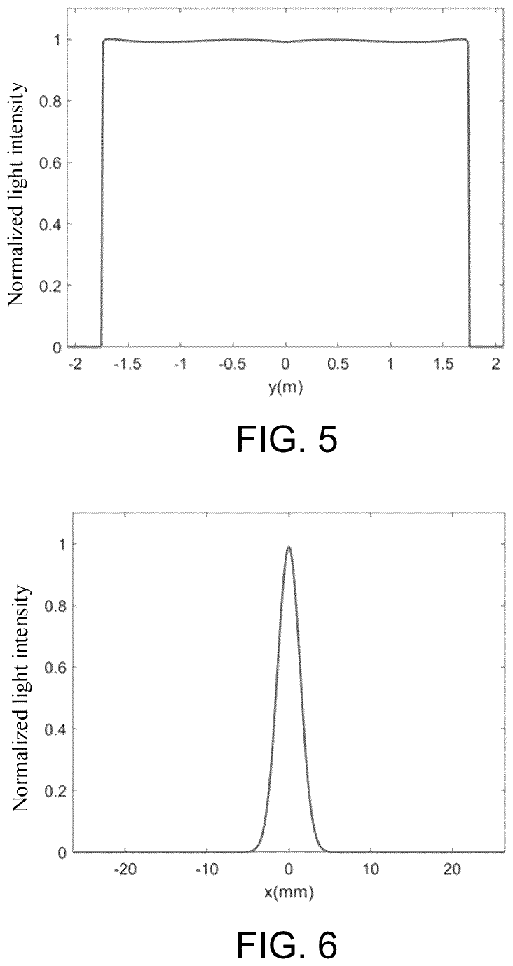

FIG. 4 shows a diagram of the spot of the line-shape beam in one embodiment. FIG. 5 shows a schematic diagram of the distribution of the normalized light intensity in the expansion direction of the generated line-shape beam in the embodiment of FIG. 4. FIG. 6 shows a schematic diagram of the distribution of the normalized light intensity in the line width direction generated in the embodiment of FIG. 4.

As shown from FIG. 4 to FIG. 6, in one embodiment, the point light source emits Gaussian beams with a central wavelength of 520 nm; the metalens is used to expend and uniform the beams in the expended direction (in the direction of x axis), and there is no special design in the line width direction (in the direction of y axis).

Therefore, the metalens is used to shape the beams emitted by the point light source to obtain the line-shape beam with the divergence angle of 120°. The line spot of the line-shape beam is projected on the beam observation surface at a distance of 1 m from the metalens, and the line spot is shown as FIG. 4. According to the calculation of FIG. 5 and FIG. 6, the uniformity performance A of the line-shape beam is 0.48%, thus the line-shape beam having high uniformity on the beam observation surface at the distance of 1 m from the metalens. And the diffraction efficiency is 99.3%, which indicates the metalens can utilize the incident light energy efficiently.

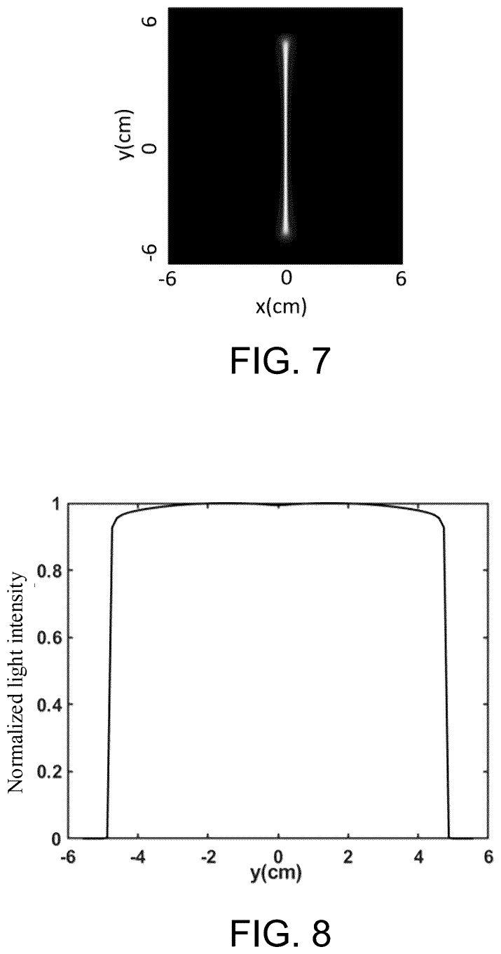

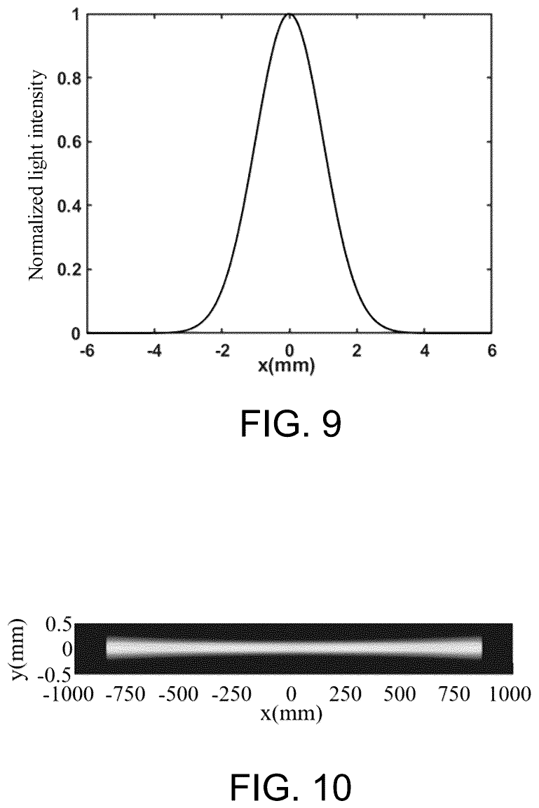

FIG. 7 shows a schematic spot view of a line-shape beam generated in an embodiment of the present application. FIG. 8 shows a schematic diagram of the distribution of the normalized light intensity of the generated line-shape beam in the expanded direction in the embodiment of FIG. 7. FIG. 9 shows a schematic diagram of the distribution of normalized light intensity in the line width direction generated in the embodiment of FIG. 7.

As shown from FIG. 7 to FIG. 9, in one embodiment, the point light source emits Gaussian beams with a central wavelength of 940 nm; the metalens is used to expend and uniform the beams in the expended direction (in the direction of y axis), and there is no special treatment in the line width direction (in the direction of x axis).

Therefore, the metalens is used to shape the beams emitted by the point light source, so as to obtain the line-shape beam with a divergence angle of 53.1°. The line spot of the line-shape beam is projected on the beam observation surface at a distance of 1 m from the metalens, and the line spot is shown as FIG. 7. According to the calculation of FIG. 8 and FIG. 9, the uniformity performance A of the line-shape beam is 1.34%, thus the line-shape beam has high uniformity on the beam observation surface at the distance of 1 m from the metalens. And the diffraction efficiency is 89.6%, which indicates the metalens can use the incident light energy efficiently.

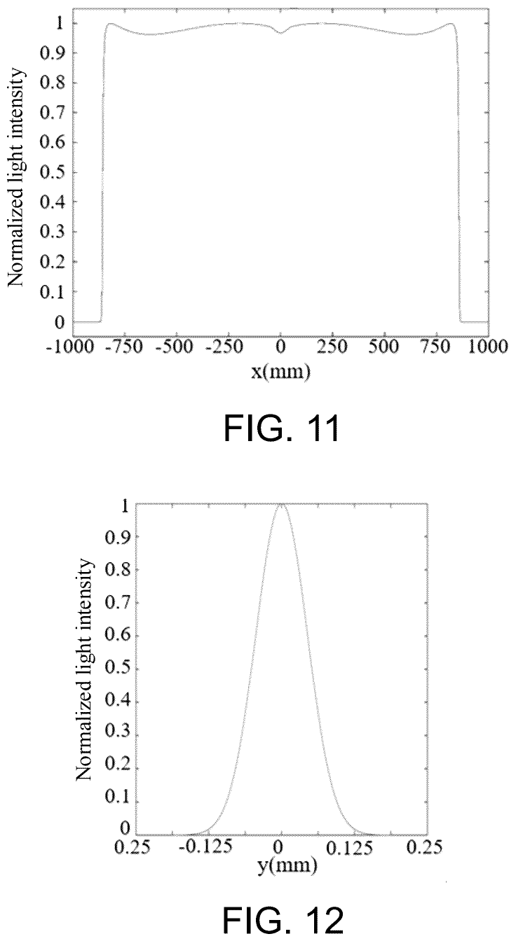

FIG. 10 shows a diagram of the spot of the line-shape beam in one embodiment. FIG. 11 shows a schematic diagram of the distribution of the normalized light intensity in the expansion direction of the generated line-shape beam in the embodiment of FIG. 10. FIG. 12 shows a schematic diagram of the distribution of the normalized light intensity in the line width direction generated in the embodiment of FIG. 10.

As shown from FIG. 10 to FIG. 12, in one embodiment, the point light source emits the Gaussian beams with a central wavelength of 850 nm; the metalens is used to expend and uniform the beams in the expended direction (in the direction of x axis), and there is no special treatment in the line width direction (in the direction of y axis).

Therefore, the metalens is used to shape the beams emitted by the point light source, so as to obtain the line-shape beam with a divergence angle of 80°. The line spot of the line-shape beam is projected on the beam observation surface at a distance of 1 m from the metalens, and the line spot is shown as FIG. 10. According to the calculation of FIG. 11 and FIG. 12, the uniformity performance A of the line-shape beam is 1.91%, thus the line-shape beam has high uniformity on the beam observation surface at the distance of 1 m from the metalens. And the diffraction efficiency is 98.44%, which indicates the metalens can use the incident light energy efficiently.

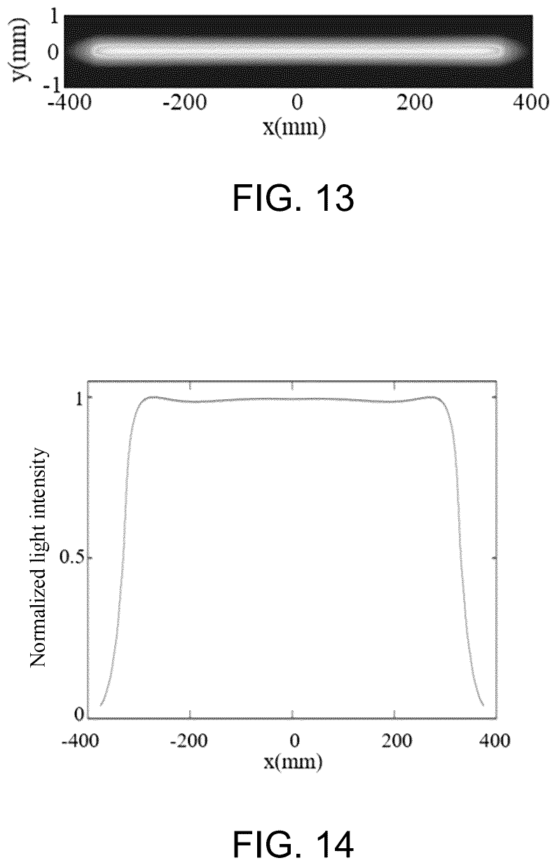

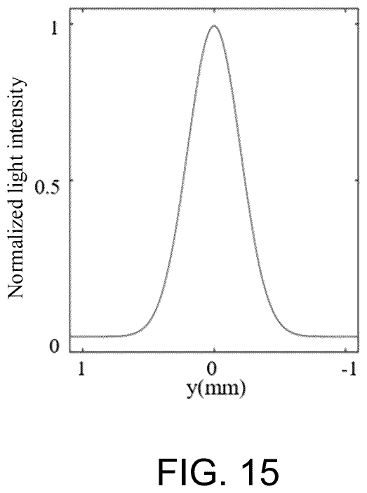

FIG. 13 shows a diagram of the spot of the line-shape beam in one embodiment. FIG. 14 shows a schematic diagram of the distribution of the normalized light intensity in the expanded direction of the generated line-shape beam in the embodiment of FIG. 13. FIG. 15 shows a schematic diagram of the distribution of the normalized light intensity in the line width direction generated in the embodiment of FIG. 13.

As shown from FIG. 13 to FIG. 15, in one embodiment, the point light source array is composed of the eleven point light sources, and each interval between adjacent point light source in the direction of x axis is 22 μm. The point light source emits Gaussian beams with a central wavelength of 855 nm, and the divergence angle (full width at half maximum) in the direction of x axis is 7°, and the divergence angle (full width at half maximum) in the direction of y axis is 18°. The generated metalens expands the beam in the expended direction (in the direction of x axis), and compresses the line width in the line width direction (in the direction of y axis).

Therefore, the metalens is used to shape the beams emitted by the point light source to obtain the line-shape beam with the divergence angle of 60°. The line spot of the line-shape beam is projected on the beam observation surface at a distance of 0.5 m from the metalens, and the line spot is shown as FIG. 13. According to the calculation of FIG. 14 and FIG. 15, the uniformity performance A of the line-shape beam is 0.73%, thus the line-shape beam has high uniformity on the beam observation surface at the distance of 0.5 m from the metalens. And the diffraction efficiency is 81.38%, which indicates the metalens can use the incident light energy efficiently.

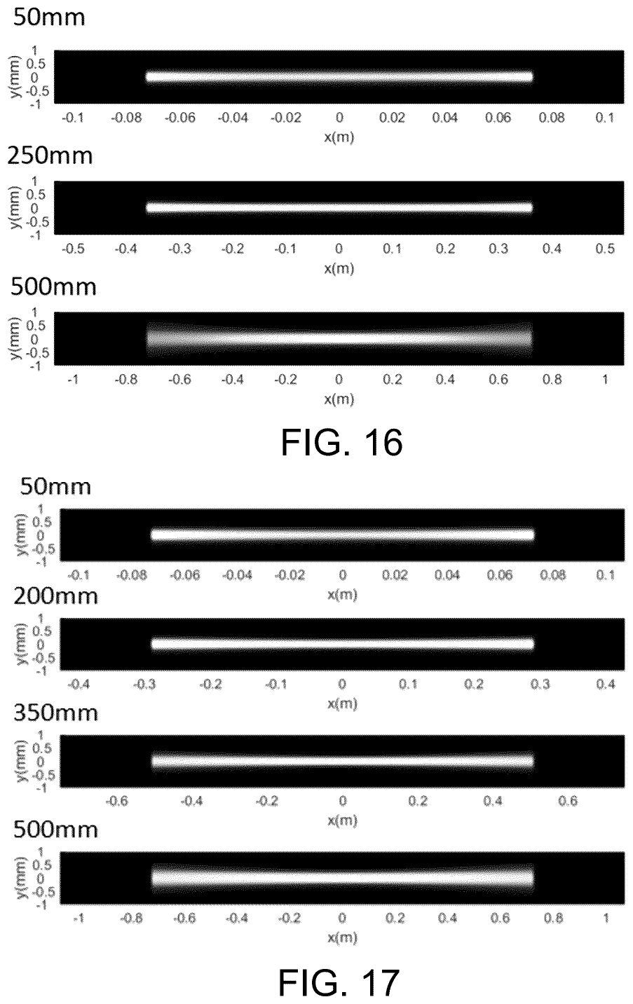

FIG. 16 shows a schematic diagram of a spot obtained by the line-shape beam generated in an embodiment of this application. FIG. 17 shows a schematic diagram of a spot obtained by the line-shape beam generated in the metalens of an embodiment of this application.

In one embodiment, in FIG. 16, the beams emitted by the point light source of EEL (Edge-emitting lasers) have a central wavelength of 850 nm, and the divergence angle (full width at half maximum) of the beams in the direction of x axis is 6° and the divergence angle (full width at half maximum) of the beams in the direction of y axis is 19°. The metalens generated according to the generating method is only used to expend the line-shape beams in the expended direction (in the direction of x axis) and not to compress the line width in the line width direction (in the direction of y axis).

Thus, in the embodiment of FIG. 16, the metalens is used to shape the beams emitted by EEL (Edge-emitting lasers) to obtain line-shape beams with a divergence angle of 110°; four spots of the line-shape beams project on the beam observation surface at a distance from the metalens of 0.05 m, 0.2 m, 0.35 m and 0.5 m as shown in FIG. 15.

In one embodiment of FIG. 16, the uniformity performance A of the line-shape beam is 13.14% on the beam observation surface at the distance of 0.05 m from the metalens, and the uniformity performance A of the line-shape beam is 10.39% on the beam observation surface at the distance of 0.2 m from the metalens. The uniformity performance A of the line-shape beam is 16.33% on the beam observation surface at the distance of 0.35 m from the metalens, and the uniformity performance A of the line-shape beam is 23.87% on the beam observation surface at the distance of 0.5 m from the metalens. And the uniformity performance A of the line-shape beam is 0.67% on the beam observation surface at the distance of 0.25 m from the metalens.

Therefore, in one embodiment of FIG. 16, on the beam observation surfaces within 0.05 m-0.5 m, the minimum value of the uniformity performance A of the line-shape beam is about 0.67%, and the maximum value of the uniformity performance A of the line-shape beam is about to be 23.87%. The uniformity of the line-shape beams on the beam observation surface at a distance of 0.25 m from the metalens is high. Moreover, on the beam observation surface within 0.05 m-0.5 m, the minimum value of the line-shape beam is about 0.7 mm, and the maximum value of the edge position of the line width is about 1.5 mm. Moreover, the diffraction efficiency of the metalens reaches 97.5%, thus indicating that the metalens can utilize the incident light energy efficiently.

Compared with the embodiment of FIG. 16, the main difference between FIG. 17 and FIG. 16 is that the metalens generated by the method provided in this application isn't only used to retract a line-shape beam in the expended beam direction, but also compress the line width in the line width direction.

Therefore, in the embodiment of FIG. 17, the metalens is used to shape the incident beams emitted by the point light source, so as to obtain the line-shape beam with the divergence angle of 110°; four spots of the line-shape beams project on the beam observation surface from the metalens of 0.05 m, 0.2 m, 0.35 m and 0.5 m as shown in FIG. 17.

In embodiment of FIG. 17, the uniformity performance A of the line-shape beam is 13.11% on the beam observation surface at the distance of 0.05 m from the metalens, and the uniformity performance A of the line-shape beam is 0.69% on the beam observation surface at the distance of 0.2 m from the metalens. The uniformity performance A of the line-shape beam is 12.12% on the beam observation surface at the distance of 0.35 m from the metalens, and the uniformity performance A of the line-shape beam is 12.33% on the beam observation surface at the distance of 0.5 m from the metalens.

Therefore, in one embodiment of FIG. 17, on the beam observation surfaces within 0.05 m-0.5 m, the minimum value of the uniformity performance A of the line-shape beam is about to be 0.69%, and the maximum value of the uniformity performance A of the line-shape beam is about to be 12.12%. The uniformity of the line-shape beams on the beam observation surface at the distance of 0.2 m from the metalens is high. Moreover, on the beam observation surface within 0.05 m-0.5 m, the minimum value of the line-shape beam is about 0.7 mm, and the maximum value of the edge position of the line width is about 1.2 mm. Moreover, the diffraction efficiency of the metalens reaches 97.5%, thus indicating that the metalens can efficiently utilize the incident light energy.

Comparing the embodiment of FIG. 16 with the embodiment of FIG. 17, the minimum value of the uniformity performance of a line-shape beam obtained by the embodiment of FIG. 17 is 0.69%, and the minimum value of the uniformity performance of the line-shape beam obtained by the embodiment of FIG. 17 is consistent with the minimum value of the minimum value of the uniformity performance of the line-shape beam of 0.67% in the embodiment of FIG. 16; However, the maximum value of the uniformity performance of the line-shape beam obtained in FIG. 17 and the embodiment is 12.12%, which is significantly less than the maximum value of 23.87% of the uniformity performance of the line-shaped beam obtained by the embodiment of FIG. 16. Thus, the embodiment of FIG. 17 improves the uniformity of the resulting line-shape beam compared to the embodiment of FIG. 16 without the line width compression.

Moreover, the minimum value of the line width of a line-shape beam in FIG. 17 embodiment is consistent with the minimum value of 0.7 mm of the line width of the line-shaped beam of FIG. 16; however, the maximum value of the line width of the line-shape beam in FIG. 17 of 1.2 mm is significantly less than the maximum value of the line width of the line-shape beam of 1.5 mm by the embodiment of FIG. 16. It follows that the embodiment of FIG. 17 improves the line width compression compared to the embodiment of FIG. 16 without line width compression.

In conclusion, compared with the embodiment of FIG. 16 that hasn't compressed the line width, the embodiment in FIG. 17 improves the uniformity and the line width of the line-shape beam.

In one embodiment, the incident beams are Gaussian beams. The metalens is used to shape a Gaussian beam into a second flat-top beam, and is used to copy and splice the second flat-top beam to a first flat-top beam; a first divergence angle of the first flat-top beam is greater than the second divergence angle of the second flat-top beam.

Because copying-splicing will not have a significant influence on the uniformity of the beams, the difference between the uniformity of the first flat-top beam and the uniformity of the second flat-top beam is small, which can be regarded as that the uniformity of the first flat-top beam and the uniformity of the second flat-top beam is consistent. Regardless of the difference between the second divergence angle of the second flat-top beam and the first divergence angle of the first flat-top beam, the second flat-top beam can be adaptively adjusted in terms of the required copied number and the required diffraction angle after the copying, so as to successfully copy and splice the second flat-top beam into the first flat-top beam. Therefore, as long as the obtained second uniform phase can shape the Gaussian beam into a second flat-top beam of high uniformity, even if the divergence angle of the second flat-top beam is small, the metalens provided by this embodiment can successfully shape the Gaussian beam into a first flat-top beam of high uniformity and large divergence angle; the second uniform light phase only for ensuring high uniformity is easily available. Thus, the metalens provided in this embodiment can shape a Gaussian beam into a flat-top beam with both high uniformity and a large divergence angle.

It should be noted that the beam observation surface used to observe the results of beam imaging is a 2D plane, and a 2D coordinate system representing the beam observation surface includes a first-direction axis and a second-direction axis, and the first-direction axis and the second-direction axis are perpendicular to each other. In one embodiment, the first flat-top beam obtained by shaping will satisfy the characteristic of flat-top beams on both the first-direction axis and the second-direction axis. That is, the light intensity of the first flat-top beam and the light intensity of the second flat-top beam both need to show a uniform distribution in the middle region and a sharp decline in the marginal region.

Therefore, in the present application, the metalens on the first-direction axis and the second-direction axis are used to copy and splice the second flat-top beam.

If the ratio of the first divergence angle of the first flat-top beam divided by the second divergence angle of the second flat-top beam is not an integer, the copied number of the second flat-top beam will slightly exceed the actual requirements at the mathematical level, resulting in the actual divergence angle satisfying high uniformity of the first flat-top beam greater than the first divergence angle. In this case, the first flat-top beam can take into account both the high uniformity and a large divergence angle, but a partial first flat-top beam beyond the first divergence angle is like wasted, resulting in a low optical efficiency of the first flat-top beam in the region of the first divergence angle.

Therefore, in one embodiment, the first divergence is an integer multiple of the second divergence angle. Thus, the actual divergence angle satisfying the high uniformity of first flat-top beam is equal to the first divergence angle, so as to make the optical energy concentrate on the region of the first divergence angle. In this way, the first flat-top beam can satisfy high uniformity and larger divergence angle at the same time, and can also maintain a high optical efficiency.

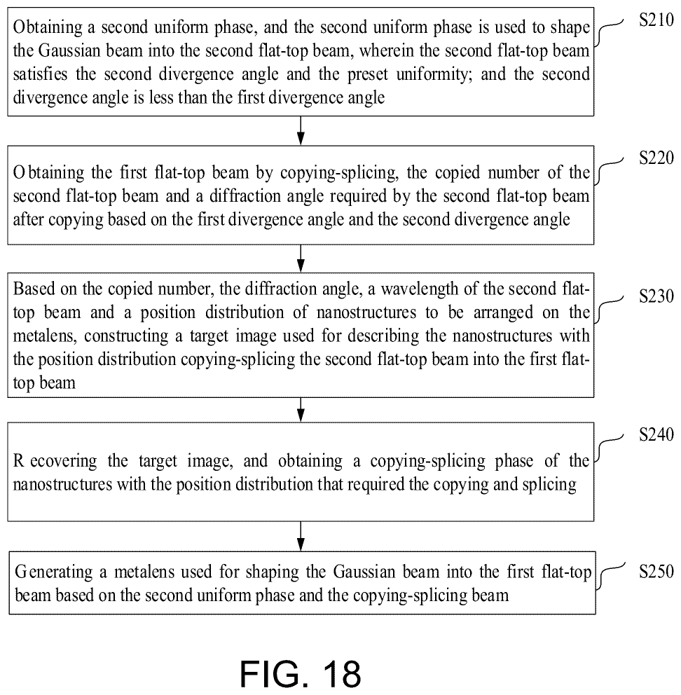

FIG. 18 shows a flowchart of a generating method of the metalens. As shown in FIG. 18, the method includes:
Step 210. obtaining a second uniform phase, and the second uniform phase is used to shape the Gaussian beam into the second flat-top beam, wherein the second flat-top beam satisfies the second divergence angle and the second divergence angle and the preset uniformity; and the second divergence angle is less than the first divergence angle;
Step 220. obtaining the first flat-top beam by copying and splicing, the copied number of the second flat-top beam and a diffraction angle required by the second flat-top beam after copying based on the first divergence and the second divergence;
Step 230. based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam;
Step 240. recovering the target image, and obtaining a copying-splicing phase of the nanostructures with the position distribution that required the copying and splicing;
Step 250. generating a metalens used for shaping the Gaussian beam into the first flat-top beam based on the second uniform phase and the copying-splicing beam.

In one embodiment, the first flat-top beam refers to the flat-top beam obtained by the shaping of the metalens; the second flat-top beam refers to the flat-top beam that can be obtained directly by the uniform light phase shaping in the prior art.

The flat-top beam that can be obtained directly by the uniform light phase shaping in the prior art is difficult to satisfy high uniformity and larger divergence angle at the same time. Therefore, in this case, a flat-top beam can't be obtained directly by shaping the Gaussian beams with the uniform light phase in the prior art. Therefore, the method provided by the present application uses the metalens to copy the second flat-top beam with a small divergence angle, and splices the copied second flat-top beam together, thus the first flat-top beam with a larger divergence angle can be obtained.

Specifically, to enable the metalens can copy and splice the second flat-top beam into the first flat-top beam, the nanostructures on the metalens to be arranged need to provide the phase used to realize the copying-splicing, that is, the copying-splicing phase of the present application.

In order to determine the copying-splicing phase, after determining the first divergence angle of the first flat-top beam and the second divergence angle of the second flat-top beam, based on the first divergence angle of the first flat-top beam and the second divergence angle of the second flat-top beam, the copied number of the second flat-top beam needed to be copied to obtain the first flat-top beam may be obtained by calculation.

After calculating the copied number, combined with the second divergence angle, applying the principle of diffraction, the diffraction angle required for the second flat-top beam is further calculated after copying.

After calculating the copied number required for the second flat-top beam and the diffraction angle required for the second flat-top beam after copying, the target image for describing the second flat-top beam copied and spliced by the second flat-top beam and the position distribution of the nanostructures to be arranged on the metalens.

Since the target image describes the execution subject of the copying-splicing process (that is, the nanostructure of the position distribution), and describes the execution of the copying-splicing process (that is, copying-splicing of beams), the processing object of the copying-splicing process (that is, the second flat-top beams) and the processing result of the copying-splicing process (that is, the first flat-top beam). Therefore, the phase description of the copying-splicing process is obtained by the recovering of the nanostructures obtained by distribution. That is, the copying-splicing phase required by the nanostructures with the position distribution is obtained. And the target image can be recovered based on the GS algorithm (Gerchberg-Saxton algorithm), and the target image can be recovered based on the grating principle.

Since the second uniform phase can shape a Gaussian beam into a second flat-top beam, and the copying-splicing phase can copy and splice the second flat-top beam into the first flat-top beam, the target phase required by the nanostructures on the metalens to shape a Gaussian beam into the first flat-top beam is determined by combining the second uniform phase and the copying-splicing phase. After determining the target phase, the nanostructures that can provide the target phase can be searched and selected in a pre-established nanostructure database. These selected nanostructures are then arranged to design the layout of the metalens. Finally, the metalens is fabricated based on the designed layout to generate a metalens that can shape a Gaussian beam into the first flat-top beam.

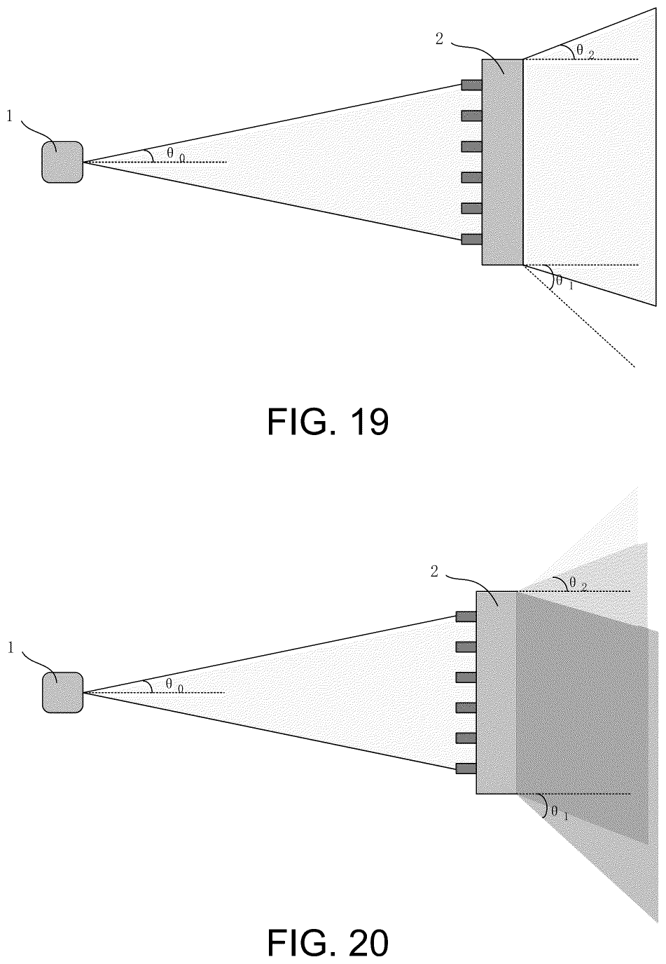

FIG. 19 shows a schematic diagram of shaping a Gaussian beam into a second flat-top beam according to one embodiment of the present application. FIG. 20 shows a schematic diagram of copying-splicing the second flat-top beam shown in FIG. 19 into the first flat-top beam according to one embodiment of the present application.

Referring to FIG. 19 and FIG. 20, in one embodiment, the divergence angle of the Gaussian beam emitted by the light source 1 is θ₀. The target embodiment uses the metalens 2 to shape the Gaussian beam with a divergence angle of θ₀ into a highly uniform flat-top beam with a divergence angle of θ₂. However, if the uniform phase provided by the prior art is used directly, on the premise of ensuring the high uniformity, the divergence angle of the flat-top beam shaped by the metalens 2 can only reach θ₂, and θ₂ is less than θ₁.

The flat-top beam with the divergence angle of θ₁ is regarded as the first flat-top beam, and the flat-top beam with the divergence angle of θ₂ is regarded as the second flat-top beam, and the uniform phase provided by the prior art is regarded as the second uniform phase. The copying-splicing phase is obtained by the calculation provided by the present application, combined with the second uniform phase, the metalens 2 used to shape the Gaussian beams with the divergence angle of θ₀ into the first flat-top beam with the divergence angle of θ₁ is generated.

As shown in the FIG. 20, the process of the metalens 2 shaping a Gaussian beam with the divergence angle of θ₀ into a first flat-top beam with a divergence angle of θ₁ may be regarded as the process of firstly shaping the Gaussian beam with a divergence angle of θ₀ into a second flat-top beam with a divergence angle of θ₂, and then copying-splicing phase the second flat-top beam with a divergence angle of θ₂ to form the first flat-top beam with a divergence angle of θ₁.

It is understandable that, since all the copied second flat-top beams are emitted from the metalens 2, there will be some degrees of overlap between them when they are just emitted from the metalens 2. Therefore, in FIG. 20, the first flat-top beam formed by the concatenation of the copied second flat-top beams just emitted from the metalens 2 will exhibit an uneven intensity distribution. However, after propagating a certain distance, the overlap between the copied second flat-top beams will decrease to a negligible level, and thus will no longer adversely affect the uniformity of the spliced first flat-top beam.

In one embodiment, the step of “obtaining the first flat-top beam by copying and splicing, the copied number of the second flat-top beam and a diffraction angle required by the second flat-top beam after copying based on the first divergence angle and the second divergence angle” includes:
obtaining the copied number by calculating a ratio of the first divergence angle to the second divergence angle;
obtaining the diffraction angle by calculating the copied number by calculating the copied number and the second divergence angle; wherein the diffraction angle is positively correlated with the copied number, and is positively correlated with the second divergence angle.

In one embodiment, after determining the first divergence angle satisfying the first flat-top beam and the second divergence angle satisfying the second flat-top beam, the second divergence may be divided by the second divergence angle, then the ratio of the second divergence angle is rounded up to an integer, that is, the copied number of the second flat top beam is calculated and obtained.

Based on the diffraction principle, the applicants found that the diffraction angle is positively correlated with the copied number, and is positively correlated with the second divergence angle. That is, with the increasing of the copied number, the diffraction angle required by the second flat-top beam shows a growth trend. With the increase of the second divergence angle, the diffraction angle required by the second flat-top beam shows a growth trend. Therefore, based on the experimental data of the diffraction principle, a semi-empirical formula can be established to describe the mathematical correlation between the diffraction angle and the copied number of the second divergence angle required by the second flat-top beam after copying. After calculating and obtaining the copied number, the diffraction angle required for the second flat-top beam is obtained by calculating the second divergence angle and the semi-empirical formula.

In one embodiment, after calculating the ratio of the first divergence angle to the second divergence angle, if the ratio isn't an integer, the second divergence angle of the second flat-top beam is adjusted, so that the ratio is an integer.

In detail, if the ratio of the first divergence angle to the second divergence angle isn't an integer, the copied number of the second flat-top beam will go beyond the actual requirement on the mathematical level, thus causing the actual divergence angle of the first flat-top beam satisfying the high uniformity is greater than the first divergence angle. In this case, the first flat-top beam is able to satisfy the high uniformity and larger divergence angle at the same time, but a partial first flat-top beam beyond the first divergence is equivalent to being wasted, resulting in its low optical efficiency at the first divergence angle region.

Therefore, in the present embodiment, by adjusting the second divergence angle of the second flat-top beam, the ratio of the first divergence angle to the second divergence angle is an integer, so that the actual divergence angle satisfying the high uniformity of the first flat-top beam is equal to the first divergence angle, and the light energy is concentrated in the first divergence angle region. In this way, the first flat-top beam can not only achieve both high uniformity and larger divergence angle, but also have high optical efficiency.

In one embodiment, a 2D coordinate system representing a beam observation surface includes a first-direction axis and a second-direction axis, and the first-direction axis and the second-direction axis are perpendicular to each other; the metalens on the first-direction axis and the second-direction axis are used to copy and splice the second flat-top beam.

It should be understood that a beam observation surface is a 2D plane, thus the beam observation surface includes a first-direction axis and a second-direction axis. In the present application, the first flat-top beam is shaped

Therefore, in the present embodiment, the second flat-top beam is shaped and obtained by the second uniform phase, and the second flat-top beam satisfies the characteristic of the flat-top beam both on the first-direction axis and the second-direction axis.

The divergence angle θₓ of the first flat-top beam and the divergence angle α of the second flat-top beam satisfied the target requirement on the first-direction axis are determined. Then the divergence angle θₓ is divided by the divergence angle α, and the obtained ratio is rounded up to an integer to obtain the copied number M of the second flat-top beam on the first-direction axis. And combined the copied number M with the divergence angle α, the diffraction angle μₓ of the second flat-top beam on the first-direction axis is calculated by the semi-empirical formula: μₓ=f(M, α).

Similarly, the divergence angle θ_{y} of the first flat-top beam on the second-direction axis and the divergence angle β of the second flat-top beam satisfied the target requirement on the second-direction axis are determined. Then the divergence angle θ_{y} is divided by the divergence angle β, and the obtained ratio is rounded up to an integer to obtain the copied number N of the second flat-top beam on the second-direction axis. And combined the copied number N with the divergence angle β, the diffraction angle μ_{y}, of the second flat-top beam on the second-direction axis is calculated by the semi-empirical formula: μ_{y}=f(N, β).

Then, based on the copied number M required on the first-direction axis, the required diffraction angle μₓ, the copied number N required on the second axis, the diffraction angle μ_{y} required on the second axis, the wavelength of the second flat-top beam and the position distribution of nanostructures to be arranged, the target image used for 2D shaping is established. Further, the target image is performed on the phase recovery, and the copying-splicing phase used for 2D shaping is obtained. And then the first flat-top beam is obtained by combining the second uniform phase and copying-splicing phase.

In one embodiment, “based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam” includes:
calculating the sampling number of the nanostructures to be arranged based on the diameter of the spot that the Gaussian beam projects on the metalens and the sampling period of the nanostructures to be arranged; and the sampling period and the sampling number constitute the position distribution;
calculating and obtaining a period of the pixels to be arranged in the target image based on the copied number, the diffraction angle, the wavelength of the second flat-top beam, the sampling period and the sampling number;
determining a target size of the target image based on the sampling period and the sampling number; according to the copied number and the arranged period, obtaining the target image by arranging the pixels in the target size image; wherein the target the pixel array is composed of the pixels of the copied number, and the distance between the adjacent pixels satisfies the arranged period.

It should be noted that the position distribution of the nanostructures to be arranged on the metalens mainly contains two parts: the sampling period of the nanostructures to be arranged and the sampling number. And the sampling period of the nanostructures to be arranged is mainly used to describe the interval between the adjacent nanostructures; the sampling number of the nanostructures to be arranged is mainly used to describe the number of nanostructures to be arranged on the corresponding dimension. It should be understood that after determining the sampling period and the sampling number, the position distribution of the nanostructures to be arranged is determined.

In the present embodiment, for the nanostructures to be arranged, the corresponding sampling period is preset. Therefore, to determine the position distribution, the sampling number needs to be determined. So in the present application, for the spot that the Gaussian beam projecting on the metalens, the biggest light intensity of the spot may be measured firstly, then the position of the 1/e² biggest light intensity of the spot is measured; the position of 1/e² biggest light intensity is an edge position of the spot; the diameter of the spot of the central position may be determined by the edge position of the spot and the central position of the spot.

Because the diameter of the spot is used to describe the range of the modulated lights required by the metalens, based on the diameter of the spot, the metalens

Moreover, in the present application, by arranging the pixel array in the target image, the target image is made to describe the process of copying-splicing the second flat-top beam into the first flat-top beam by using nanostructures with the sampling period and the sampling number.

Specifically, according to the sampling period and the sampling number, determining the target size of pixels in the target image, thus the target image will have the able to describe the process of copying-splicing (that is, the nanostructures of the sampling period and the sampling number). According to the copying number, arranging the pixel array composed of the pixels of the copied number in the target image of the target size of the pixels, thus the target image has the ability of describing the copying-splicing process to execute actions but doesn't have the ability of describing the copying-splicing process to the processing objects and processing results (that is, if only the number of the pixels is determined, the target image is only able to describe “copying-splicing a certain beam”, but isn't able to describe “which kind of beam is copied and spliced” or “which kind of beam is obtained after copying-splicing”).

Therefore, to further enhance the ability of the target image to describe the processing objects and results of the copying-splicing process, in this embodiment, applying the diffraction principle, based on the required copied number of the second flat-top beam, the diffraction angle required by the second flat-top beam after copying, the wavelength of the second flat-top beam, the sampling period of the nanostructures to be arranged, and the sampling number, the arrangement period of the pixel arrays to be arranged in the target image is calculated. This arrangement period is mainly used to describe the distance between adjacent pixels in the pixel array; and the distance between adjacent pixels is primarily described by the number of unit distances between adjacent pixels (for example: the target image is a 100*100 pixel array with the unit distance between the adjacent pixels of a size of a single pixel; simultaneously, the pixel array to be arranged consists of 3*3 pixels, and the arrangement period of the pixel array is 4. Therefore, in the pixel array of 100*100, a pixel array is arranged in 3*3, and the distance between adjacent pixels is controlled to be the size of 4 pixels).

Therefore, according to the required copied number, the pixel array consisting of the specified number of pixels is arranged in the target-sized image, and the distance between adjacent pixels in the pixel array is controlled according to the arrangement period. This results in a target image that doesn't only describes the execution subject of the copying-splicing process (that is, the nanostructures with the determined sampling period and sampling number) but also describes the execution actions of the copying-splicing process (that is, the copying-splicing of a specific beam), the processing object of the copying-splicing process (that is, the second flat-top beam), and the processing result of the copying-splicing process (that is, the first flat-top beam).

In one embodiment, based on the diameter of the spot that the Gaussian beam projects on the metalens and the sampling period of the nanostructures to be arranged, calculating the sampling number of the nanostructures to be arranged includes:
calculating and obtaining the size of the metalens of the target requirements based on the spot diameter, and the size of the metalens is positively correlated with the spot diameter;
calculating and obtaining the sampling number based on the ratio of the sampling period to the size of the metalens.

In this embodiment, the size of the metalens of target requirements is positively correlated with the diameter of the spot of Gaussian beam incident on the surface. The larger the spot diameter, the larger the size of the metalens of target requirements. After calculating the size of the metalens of target requirements, the size is divided by the sampling period of the nanostructures to be arranged, and the result is rounded up to obtain the sampling number of the nanostructures to be arranged.

In one embodiment, based on the required copied number, the diffraction angle, the wavelength, the sampling period, and the sampling number, calculating the arrangement period of the pixel arrays to be arranged in the target image includes:
calculating the maximum diffraction angle of the copied second flat-top beam based on the wavelength and the sampling period, and the maximum diffraction angle is positively correlated with the wavelength and negatively correlated with the sampling period;
calculating the arrangement period based on the maximum diffraction angle, the required copied number, the diffraction angle, and the sampling number, wherein the arrangement period is negatively correlated with the maximum diffraction angle and the required copied number, and positively correlated with the diffraction angle and the sampling number.

The applicants of this application has made the following discoveries based on the diffraction principal: I. In this application, the arrangement period of the pixel arrays to be arranged in the target image is primarily constrained by four factors: the maximum diffraction angle that the copied second flat-top beam, the required copied number of the second flat-top beam, the diffraction angle needed after copying of the second flat-top beam, the sampling number of the nanostructures to be arranged. Specifically, the arrangement period of the pixel arrays is negatively correlated with the maximum diffraction angle that the copied second flat-top beam, and is negatively correlated with the required copied number of the second flat-top beam, positively correlated with the diffraction angle needed after replication of the second flat-top beam, and is positively correlated with the sampling number of the nanostructures to be arranged. II. The maximum diffraction angle that the copied second flat-top beam is primarily constrained by two factors: the wavelength of the second flat-top beam, and the sampling period of the nanostructures to be arranged. Specifically, the maximum diffraction angle that the copied second flat-top beam is positively correlated with the wavelength of the second flat-top beam and negatively correlated with the sampling period of the nanostructures to be arranged.

Therefore, in the present application, firstly based on the wavelength of the second flat-top beam and the sampling period of the nanostructures to be arranged, the maximum diffraction angle that the copied second flat-top beam is calculated. Then based on the maximum diffraction angle that the copied second flat-top beam, the copied number required by the second flat-top beam, the diffraction angle required by the copied second flat-top beam, the copied number required by the second flat-top beam, the diffraction angle required by the copied second flat-top beam and the sampling number of the nanostructures to be arranged, the arrangement period of the pixel array to be arranged in the target image.

In one embodiment, the divergence angle (half angle) of the Gaussian beam emitted by the light source is 13°, and the center wavelength of the Gaussian beam is 850 nm, and the distance between the light source and the phase-modulation surface of the metalens is 1.4 mm. The metalens is a regular square, and the sampling period of the nanostructures to be arranged on the substrate of metalens is 0.4 μm. The distance between the metalens and the beam observation beam is 50 cm.

In the present application, the flat-top beam obtained by shaping needs to satisfy the characteristic of the flat-top beam on both the horizontal direction and the vertical direction of the beam observation surface. Specifically, in the premise of ensuring high uniformity, the metalens needs to be able to shape Gaussian beams into the first flat-top beams with divergence angle of 60° (half angle) in the horizontal and vertical direction. If the second uniform phase is used directly adopted, the metalens can only shape Gaussian beams into the second flat-top beams with the divergence angle of 20° (half angle) in the horizontal and vertical direction.

The wavelength of the second flat-top beam is λ; the diameter spot of the Gaussian beam that projects on the metalens is ω; the sampling period of the nanostructures to be arranged is P, the sampling number on the horizontal direction is NPₓ, the sampling number on the vertical direction is NP_{y}; the divergence angle of the first flat-top beam on the horizontal direction is θₓ, and the divergence angle of the first flat-top beam on the vertical direction is θ_{y}; the divergence angle of the second flat-top beam on the horizontal direction is α, and the divergence angle of the second flat-top beam on the vertical direction is β; the copied number required by the second flat-top beam on the horizontal direction is M, and the copied number required by the second flat-top beam on the vertical direction is N. The diffraction angle required by the copied second flat-top beam on the horizontal direction is μₓ, and the diffraction angle required by the copied second flat-top beam on the horizontal direction is μ_{y}. The arrangement period of the pixels to be arranged in the target image on the horizontal direction is npₓ, and the arrangement period of the pixels to be arranged in the target image on the vertical direction is np_{y}.

The wavelength λ of second flat-top beam is same as the wavelength of the Gaussian beam of 850 nm; the diameter ω of spot is 646 μm; the sampling period P is 0.4 μm. The divergence angle θₓ of the first flat-top beam on the horizontal direction is 60°, and the divergence angle θ_{y} of the first flat-top beam on the vertical direction is 60°. The divergence angle α of the second flat-top beam on the horizontal direction is 20°, and the divergence angle β of the second flat-top beam on the vertical direction is 20°. Therefore, M, N, μₓ, μ_{y}, NPₓ, NP_{y} may be calculated by the following formula:

$$M = ⌈ \frac{{θ}_{x}}{α} ⌉ = ⌈ \frac{60 °}{20 °} ⌉ = 3 \\ N = ⌈ \frac{{θ}_{y}}{β} ⌉ = ⌈ \frac{60 °}{20 °} ⌉ = 3 \\ {μ}_{x} = f ( M , α ) = f ( 3 , 20 ° ) = 40 ° \\ {μ}_{y} = f ( N , β ) = f ( 3 , 20 ° ) = 40 ° \\ {NP}_{x} = ⌈ \frac{1.5 ω}{P} ⌉ = ⌈ \frac{1.5 * 646}{0.4} ⌉ = 2423 \\ {NP}_{y} = ⌈ \frac{1.5 ω}{P} ⌉ = ⌈ \frac{1.5 * 646}{0.4} ⌉ = 2423$$

Therefore, based on the wavelength A of the second flat-top beam and the sampling period P of nanostructures to be arranged, the maximum divergence angle obtained by the copied second flat-top beam in the horizontal direction is calculated. Thus, the arrangement period of the pixel array npₓ in the horizontal direction is calculated based on the maximum diffraction angle by the second flat-top beam in the horizontal direction, the copied number M required in the horizontal direction, the diffraction angle μₓ required in the horizontal direction, and the sampling number of NPₓ nanostructures in the horizontal direction. And the obtained value of npₓ is 957.

Similarly, the maximum divergence angle of the copied second flat-top beam is calculated based on the wavelength λ of the second flat-top beam and the sampling period of nanostructures to be arranged, and then the arrangement period of the pixel array np_{y} in the vertical direction is calculated based on the maximum diffraction angle by the second flat-top beam in the vertical direction, the copied number M required in the vertical direction, the diffraction angle μ_{y} required in the vertical direction, and the sampling number of NP_{y} nanostructures in the vertical direction. And the obtained value of np_{y} is 957.

Therefore, the target image is set to be an array of NPₓ*NP_{y}, that is, the size of the array is 2423*2423. The value of each pixel in the pixel array is set as 1, and the value of pixels outside the pixel array is set as 0; the arrangement period of the pixels of the pixel array in the horizontal direction is npₓ, and the arrangement period in the vertical direction is np_{y}; that is, the arrangement period of the pixels in the pixel array in the horizontal direction is 957, and the arrangement period of the pixels in the pixel array in the vertical direction is 957. The value of the pixels in the pixel array of the target image represents the normalized light intensity of the corresponding pixel; if the value of a point in the target image is set as 1, the normalized light intensity of the corresponding pixel is set as the highest value of 1; otherwise, if the value of a pixel in the target image is set as 0, the normalized light intensity of the corresponding pixel is set as the lowest value of 0.

After constructing the target image, the GS algorithm is applied to recover the corresponding phase of the target image. Then, combining the second uniform phase with the copying-splicing phase, the target phase of the nanostructures to be arranged on the metalens is obtained. After determining the target phase, the layout of the metalens is designed by selecting nanostructures in the pre-established nanostructure database; then the metalens that is used for shaping the Gaussian beams into the first flat-top beam with the divergence angle of 60° both in the horizontal and vertical directions is generated.

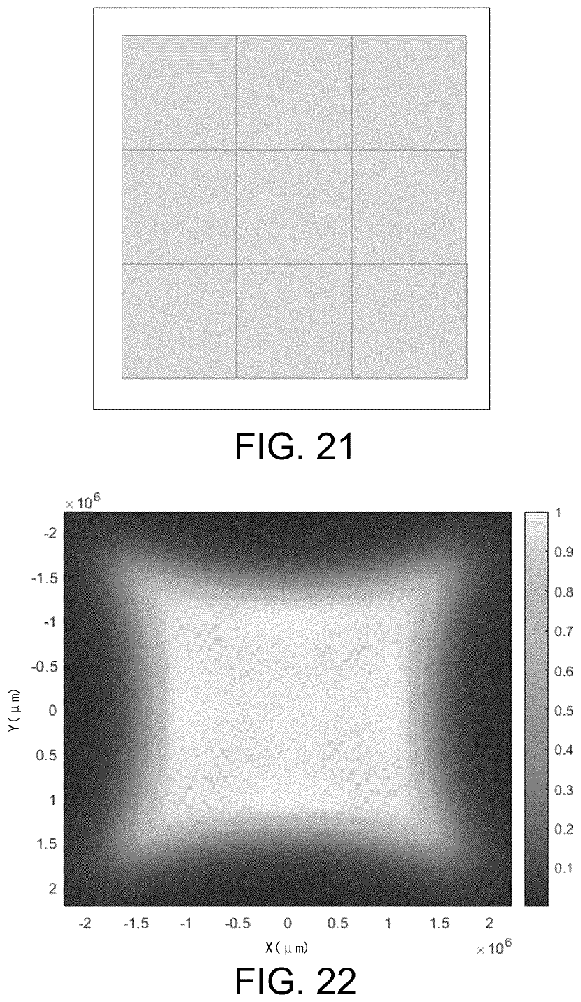

FIG. 21 shows a schematic representation of the second flat-top beam reflected in the beam observation surface. Referring to FIG. 21, the metalens generated in this embodiment is equivalent to copying three copies of the second flat-top beam in the horizontal and vertical directions and then splicing to obtain the first flat-top beam.

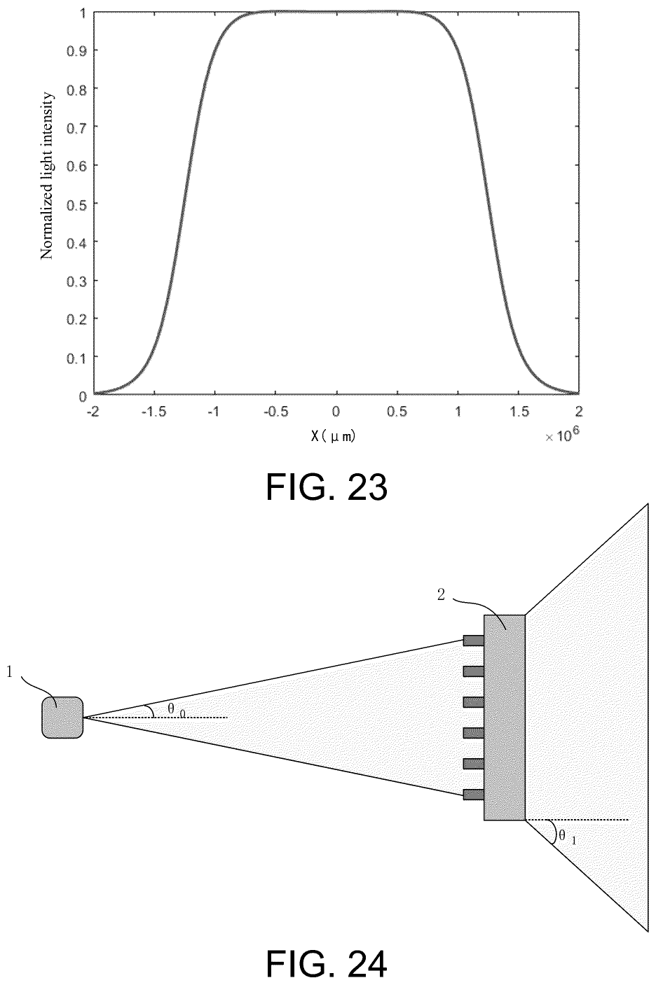

FIG. 22 shows a schematic diagram of the distribution of the 2D normalized light intensity on the beam observation surface obtained in this embodiment. FIG. 23 shows a schematic diagram of the distribution of the one-dimensional normalized light intensity in the horizontal direction of the first flat-top beam formed in the present embodiment. The horizontal axis of FIG. 23 represents the horizontal axis of the beam observation surface with the origin of the intersection of the optical axis and the beam observation surface in u m; the vertical axis of FIG. 23 represents the normalized light intensity of the beam.

The observed region in the beam observation surface used to determine the light intensity uniformity of the first flat-top beam in the horizontal direction, and the radius of the observed region is recorded as R. Since the divergence angle of the first flat-top beam in the horizontal direction is 60°, the distance between the metalens and the beam observation surface is 50 cm, and the size of the metalens is negligible compared to the distance between the metalens and the beam observation surface, then by applying the triangle theorem, R=50 cm*tan(60°), that is, R is about 8.66×10⁵ μm. That is, in the observed region of ±8.66×10⁵ μm, the uniformity of the light intensity F of the first flat-top beam with the divergence angle of 60° is determined. The uniformity of the light intensity F is calculated as follows:

$$F = 1 - \frac{{I}_{m ax} - {I}_{m i n}}{{I}_{m ax} + {I}_{m i n}}$$

Wherein, Iₘₐₓ is the maximum normalized light intensity of the observed region, and Iₘᵢₙa is the minimum normalized light intensity of the observed region.

According to the uniformity of light intensity F is 98.74% as shown in FIG. 23. That is, within the range of the divergence angle of 60°, the uniformity of the light intensity of the first flat-top beam obtained by shaping is 98.74%. It can be seen that the first flat-top beam can satisfy the high uniformity and larger divergence angle. Moreover, according to FIG. 23, the optical efficiency of the metalens in the corresponding optical system is 83.22%. It can be seen that the first flat-top beam can't only satisfy the high uniformity and larger divergence angle, but also has high optical efficiency.

The present application further provides a beam-shaping system. FIG. 24 shows a layout of the beam-shaping system. As shown in FIG. 24, in the present application, the beam-shaping system includes a light source 1 used for emitting the Gaussian beams, and a metalens 2 used for shaping the Gaussian beams. The metalens is used to shape the Gaussian beams with the divergence angle θ₀ emitted by the light source 1 into the first flat-top beams with the divergence angle θ₁. The first flat-top beam can satisfy the high uniformity and a large divergence angle at the same time.

FIG. 25 shows a block diagram of the generating device of the metalens as shown in FIG. 25, the device includes:
a shaping-analyzing module 310, and the shaping-analyzing module 310 is used for analyzing a shaping phase used to shape a parallel beam into a target light field by using a recombinant light intensity distribution; wherein an input of the recombinant light intensity is the light intensity distribution of the beam emitted by the point light source; an output of the recombinant light intensity is the light intensity distribution of a first light field, and an initial state of the first light field is set as the target light field;
a deviation detecting module 320, and the deviation detecting module 320 is used for obtaining a second light field through shaping a beam emitted by the point light source based on a superposition phase and detecting a deviation between the light intensity distribution of the second light field and the light intensity distribution of the target light field; wherein the superposition phase comprises a collimation phase and a shaping phase, and the shaping phase is used to align the beam emitted by the point light source to the parallel beams;
an optimized module for light field 330, the optical optimized module for light field 330 is used for optimizing the light intensity distribution of the first light field based on the deviation, and re-analyzing the shaping phase every time detecting the deviation is greater than a preset threshold, re-obtaining the second light field, re-detecting the deviation until the detected deviation is less than or equal to the preset threshold;
a metalens generating module 340, the generating the metalens is used for shaping the beam emitted by the point light source into a line-shape beam based on the superposition phase; and the the line-shape beam corresponds to the target light field.

In one embodiment, the shaping phase includes an expended phase, and the expended phase is used to shape the parallel beams into the line-shape beams satisfying the target divergence angle.

In one embodiment, the shaping-analyzing module is used for:
obtaining the diffraction angle of each light on the metalens based on the light intensity distribution of all lights on the metalens and the light intensity distribution of the first light field satisfying the target diffraction angle;
analyzing the expended phase based on the diffraction angle required by each light on the metalens and the refractive index of the medium on both sides of the metalens.

In one embodiment, the shaping phase includes a compressed phase for a line width, and the compressed phase for a line width is used for shaping the parallel beam into a line-shape beam that meets a target line width.

In one embodiment, the optimized module for light field 330 is used for:
adapting a pre-constructed light intensity distribution to describe the first light field, and obtaining the light intensity distribution of the first light field;
optimizing the first light field by adjusting the coefficients in the expression of the light intensity distribution of the first light field.

In one embodiment, the optimized module for light field 330 is used for:
discretizing the light intensity distribution of the first light field, so as to obtain the discretized light intensity distribution of the first light field;
optimizing the light intensity distribution of the first light field by adjusting the field.

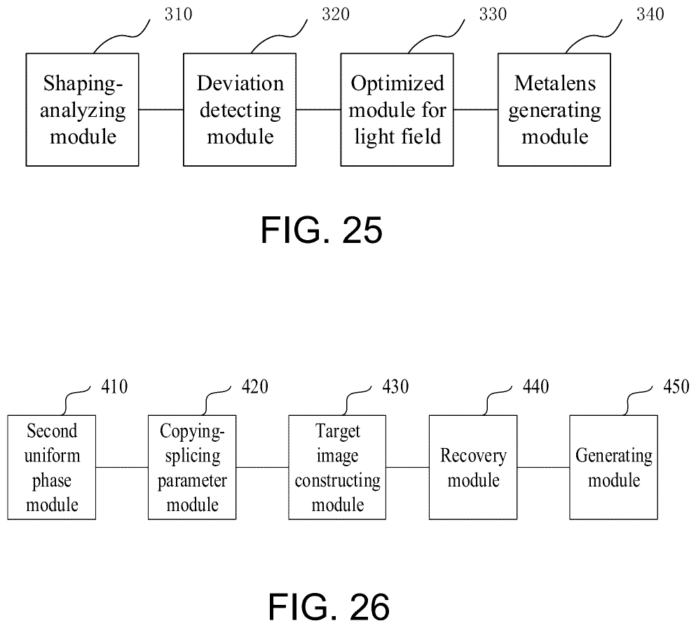

FIG. 26 shows a block diagram of the generating device of metalens in one embodiment. The metalens to be generated is used for shaping the Gaussian beam into the first flat-top beam, and the target requirement of the first flat-top beam satisfies the first divergence angle and the preset uniformity; as shown in FIG. 26, the generating device includes:
a second uniform phase module 410, the second uniform phase module 410 is used for obtaining a second uniform phase, wherein the second uniform phase is used to shape the Gaussian beam into the second flat-top beam, wherein the second flat-top beam satisfies the second divergence angle and the preset uniformity; and the second divergence angle is less than the first divergence angle;
a copying-splicing parameter module 420, and the copying-splicing parameter module 420 is used for obtaining the first flat-top beam by copying and splicing, the copied number of the second flat-top beam and a diffraction angle required by the second flat-top beam after copying based on the first divergence and the second divergence;
a target image constructing module 430, the target image constructing module 430 is used for based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam;
a recovery module 440, the recovery module 440 is used for recovering the target image, and obtaining a copying-splicing phase of the nanostructures with the position distribution that required the copying-splicing;
a generating module 450, the generating module 450 is used for generating a metalens used for shaping the Gaussian beam into the first flat-top beam based on the second uniform phase and the copying-splicing beam.

In one embodiment, the copying-splicing parameter module 420 is used for obtaining the copied number by calculating a ratio of the first divergence angle to the second divergence angle; and is used for obtaining the diffraction angle by calculating the copied number by calculating the copied number and the second divergence angle; wherein the diffraction angle is positively correlated with the copied number, and is positively correlated with the second divergence angle.

In one embodiment, the target image constructing module 430 is used for calculating the sampling number of the nanostructures to be arranged based on the diameter of the spot that the Gaussian beam projects on the metalens and the sampling period of the nanostructures to be arranged; and the sampling period and the sampling number constitute the position distribution;
calculating and obtaining a period of the pixels to be arranged in the target image based on the copied number, the diffraction angle, the wavelength of the second flat-top beam, the sampling period and the sampling number;
determining a target size of the target image based on the sampling period and the sampling number; according to the copied number and the arranged period, obtaining the target image by arranging the pixels in the target size image; wherein the target pixel array is composed of the pixels of the copied number, and the distance between the adjacent pixels satisfies the arranged period.

In one embodiment, the target image constructing module 430 is used for calculating and obtaining the size of the metalens of the target requirements based on the spot diameter, and the size of the metalens is positively correlated with the spot diameter;
and calculating and obtaining the sampling number based on the ratio of the sampling period to the size of the metalens.

In one embodiment, the diameter of the metalens is greater than or equal to 1.3 times of the spot diameter of the Gaussian beam projected on the metalens, and is less than or equal to 1.7 times of the diameter of the spot diameter.

In one embodiment, the target image constructing module 430 is used for calculating the maximum diffraction angle of the copied second flat-top beam based on the wavelength and the sampling period, and the maximum diffraction angle is positively correlated with the wavelength and negatively correlated with the sampling period;
calculating the arrangement period based on the maximum diffraction angle, the required copied number, the diffraction angle, and the sampling number, wherein the arrangement period is negatively correlated with the maximum diffraction angle and the required copied number, and positively correlated with the diffraction angle and the sampling number.

This application also provides an electronic device. The electronic device is in the form of a universal computing device. The components of the electronic device may include, but are not limited to, at least one processing unit, at least one storage unit, and buses connecting different system components (including storage units and processing units).

Wherein the storage unit is stored with a program code, which may be executed by the processing unit, causing the processing unit to execute the steps of the exemplary embodiments described in the various exemplary embodiments described above. For example, the processing unit may perform the various steps shown in FIG. 1 or FIG. 18.

The storage unit may include a readable medium in the form of a volatile storage unit, such as a random access storage unit (RAM) and/or a cache memory unit, and may further include a read-only storage unit (ROM).

The storage unit may also include a program/utility having a set of (at least one) program modules including, but not limited to, the operating system, one or more applications, other program modules, and program data, and each or some combination of these examples may include an implementation of a network environment.

A bus may be a local bus representing one or more of several types of bus structures, including a storage unit bus or a storage unit controller, a peripheral bus, a graphics acceleration port, a processing unit, or using any of these bus structures.

The present application also provides a computer-readable storage medium storing a computer-readable instruction that causes the computer to execute the method provided when the computer-readable instruction is executed by either of the processing units of the computer.

The above is only a specific embodiment of the embodiments of this application, but the scope of protection of the embodiment of this application is not limited to this. And those skilled in the field can easily think of any change or substitution for this application, which should be covered within the protection scope of this application. Therefore, the scope of the protection of the present application shall be the scope of the claims.

What is claimed is:

1. A metalens used for beam shaping, wherein the metalens is used to shape an incident beam, and a divergence angle at least in one direction of an outgoing beam obtained by shaping is greater than the divergence angle in the same direction of the incident beam.

2. The metalens used for beam shaping according to claim 1, wherein the incident beam is a Gaussian beam.

3. The metalens used for beam shaping according to claim 1, wherein a diameter of the metalens is greater than or equal to 1.3 times a spot diameter of the Gaussian beam projected on the metalens, and is less than or equal to 1.7 times the spot diameter.

4. The metalens used for beam shaping according to claim 1, wherein the metalens is used to align a beam emitted by a point light source and expand the beam emitted by the point light source in the expended direction; the outgoing shaped beam is a line-shape beam.

5. The metalens used for beam shaping according to claim 4, wherein the metalens is further used to compress a line width of the beam emitted by the point light source in a direction of the line width.

6. The metalens used for beam shaping according to claim 5, wherein the metalens is used to provide different focal lengths for beams with different divergence angles to adaptively compress the line widths of the beams with the different divergence angles.

7. The metalens used for beam shaping according to claim 1, wherein the metalens is used to shape a Gaussian beam into a second flat-top beam, and is used to copy and splice the second flat-top beam to a first flat-top beam; a first divergence angle of the first flat-top beam is greater than a second divergence angle of the second flat-top beam.

8. The metalens used for beam shaping according to claim 7, wherein a 2D coordinate system representing a beam observation surface comprises a first-direction axis and a second-direction axis, and the first-direction axis and the second-direction axis are perpendicular to each other;
the metalens is used to copy and splice the second flat-top beam both on the first-direction axis and the second-direction axis.

9. The metalens used for beam shaping according to claim 7, wherein the first divergence angle is an integer multiple of the second divergence angle.

10. A beam-shaping system, wherein the beam-shaping system includes a light source and the metalens according to claim 1,
the metalens is set on an outgoing side of the light source.

11. The beam-shaping system according to claim 10, wherein the light source is a single point light source.

12. The beam-shaping system according to claim 10, wherein the light source is an array comprising a plurality of point light sources.

13. A generating method of a metalens, wherein the method is used to generate the metalens according to claim 1, wherein the method comprises:
analyzing a shaping phase used to shape a parallel beam into a target light field by using a recombinant light intensity distribution; wherein an input of the recombinant light intensity distribution is a light intensity distribution of a beam emitted by the point light source; an output of the recombinant light intensity distribution is a light intensity distribution of a first light field, and an initial state of the first light field is set as the target light field;
obtaining a second light field by shaping the beam emitted by the point light source based on a superposition phase and detecting a deviation between the light intensity distribution of the second light field and the light intensity distribution of the target light field; wherein the superposition phase comprises a collimation phase and a shaping phase, and the shaping phase is used to align the beam emitted by the point light source to parallel beams;
every time detecting a deviation and the deviation is greater than a preset threshold, optimizing the light intensity distribution of the first light field based on the deviation, and re-analyzing the shaping phase, re-obtaining the second light field, re-detecting the deviation until the detected deviation is less than or equal to the preset threshold;
generating the metalens used for shaping the beam emitted by the point light source into a line-shape beam based on the superposition phase; and the line-shape beam corresponds to the target light field.

14. The generating method of the metalens according to claim 13, wherein the shaping phase comprises an expended phase, and the expended phase is used to shape the parallel beam into the line-shape beam with a target divergence angle.

15. The generating method of the metalens according to claim 13, wherein the shaping phase comprises a compressed phase for a line width, and the compressed phase for a line width is used for shaping the parallel beam into the line-shape beam that meets a target line width.

16. The generating method of the metalens according to claim 15, wherein the step of analyzing the shaping phase used to shape the parallel beam as the target light field by using the recombinant light intensity distribution, the method comprises:
obtaining a target focal length that the metalens provides for each light with a deflection angle, so as to make the line-shape beam satisfy the target line width;
analyzing and obtaining the compressed phase for the line phase based on the deflection angle required for each of the light on the metalens and the target focal length that the metalens provides for each of the light with the deflection angle.

17. A generating method of a metalens, the generating method is used to generate the metalens according to claim 1, wherein the metalens to be generated is used to shape a Gaussian beam into a first flat-top beam, and the first flat-top beam satisfies a first divergence angle and a preset uniformity, and the method comprises:
obtaining a second uniform phase, and the second uniform phase is used to shape the Gaussian beam into a second flat-top beam, wherein the second flat-top beam satisfies a second divergence angle and the preset uniformity; and the second divergence angle is less than the first divergence angle;
obtaining the first flat-top beam by copying and splicing, a copied number of the second flat-top beam and a diffraction angle required by the second flat-top beam after copying based on the first divergence angle and the second divergence angle;
based on the copied number, the diffraction angle, a wavelength of the second flat-top beam and a position distribution of nanostructures to be arranged on the metalens, constructing a target image used for describing the nanostructures with the position distribution copying-splicing the second flat-top beam into the first flat-top beam;
recovering the target image, and obtaining a copying-splicing phase of the nanostructures with a position distribution that required copying and splicing; generating the metalens used for shaping the Gaussian beam into the first flat-top beam based on the second uniform phase and the copying-splicing beam.

18. The generating method according to claim 17, wherein in the step of obtaining the first flat-top beam by copying and splicing, the copied number of the second flat-top beam and a diffraction angle required by the second flat-top beam after copying based on the first divergence and the second divergence, the method comprises:
obtaining the copied number by calculating a ratio of the first divergence angle to the second divergence angle; and
obtaining the diffraction angle by calculating the copied number and the second divergence angle; wherein the diffraction angle is positively correlated with the copied number, and is positively correlated with the second divergence angle.

19. The generating method according to claim 17, wherein a 2D coordinate system comprising a beam observation surface includes a first-direction axis and a second-direction axis, and the first-direction axis and the second-direction axis are perpendicular to each other; the copied number comprises a first number and a second number; the first number is the copied number required on the first directional axis, and the second number is the copied number required on the second-direction axis, the diffraction angle comprises the diffraction angle required on the first-direction axis and the diffraction angle required on the second-direction axis.

20. The generating method according to claim 17, wherein in the step of based on the copied number, the diffraction angle, the wavelength of the second flat-top beam and the position distribution of nanostructures to be arranged on the metalens, constructing a target image used for describing the nanostructures with the position distribution copying-splicing the second flat-top beam into the first flat-top beam, the method comprises:
calculating the sampling number of the nanostructures to be arranged based on the diameter of the spot that the Gaussian beam projects on the metalens and the sampling period of the nanostructures to be arranged; and the sampling period and the sampling number constitute the position distribution;
calculating and obtaining a period of the pixels to be arranged in the target image based on the copied number, the diffraction angle, the wavelength of the second flat-top beam, the sampling period and the sampling number; and
determining a target size of the target image based on the sampling period and the sampling number; according to the copied number and the arranged period, obtaining the target image by arranging the pixels in the target size image; wherein the target the pixel array is composed of the pixels of the copied number, and the distance between the adjacent pixels satisfies the arranged period.
